(19) United States
(12) Patent Application Publication
(10) Pub. No.: US 2026/0361853 A1
(43) Pub. Date: Nov. 12, 2026

(54) CODING METHOD, DECODING METHOD, CODE STREAM, CODER, DECODER, AND STORAGE MEDIUM

(71) Applicant: GUANGDONG OPPO MOBILE TELECOMMUNICATIONS CORP., LTD., Dongguan (CN)

(72) Inventors: Junyan HUO, Dongguan (CN); Yanzhuo MA, Dongguan (CN); Fuzheng YANG, Dongguan (CN); Jiaqi LIU, Dongguan (CN); Ming LI, Dongguan (CN)

(73) Assignee: GUANGDONG OPPO MOBILE TELECOMMUNICATIONS CORP., LTD., Dongguan (CN)

(21) Appl. No.: 19/732,849

(22) Filed: Jul. 7, 2026

Related U.S. Application Data
(63) Continuation of application No. PCT/CN2024/071220, filed on Jan. 8, 2024.

(51) Int. Cl. H04N 19/105; H04N 19/176; H04N 19/186

(52) U.S. Cl. CPC H04N 19/105; H04N 19/176; H04N 19/186

(57) ABSTRACT

A decoding method and an encoding method are provided. The decoding method includes: decoding a bitstream to determine a prediction parameter of a current block and a residual value of a luma component of the current block; determining a prediction reference block of the current block according to the prediction parameter; determining a reconstructed value of the luma component of the current block according to the residual value of the luma component of the current block and the luma prediction reference block; determining, according to a chroma sample in the chroma prediction reference block, a model reference luma sample set corresponding to the chroma sample; and determining a model parameter of a cross-component prediction model according to the model reference luma sample set, the residual value of the luma component of the current block, and the prediction reference block of the current block.

### CROSS-REFERENCE TO RELATED APPLICATIONS

This application is a continuation of International Application No. PCT/CN 2024/071220, filed on Jan. 8, 2024, the disclosure of which is hereby incorporated by reference in its entirety.

### TECHNICAL FIELD

Embodiments of this application relate to the field of image processing technologies, and in particular, to an encoding method, a decoding method, a bitstream, an encoder, a decoder, and a storage medium.

### BACKGROUND

An Inter Convolutional Cross Component Model (Inter Convolutional Cross Component Model, InterCCCM) is applied to an inter prediction mode and an intra prediction mode. The InterCCCM technology is mainly used to filter a luma reconstructed value, so as to correct a chroma predicted value.

However, when the chroma predicted value is corrected based on the luma reconstructed value, a good correction effect cannot be obtained, resulting in reducing of accuracy of the chroma prediction, and thus affecting the coding performance.

### SUMMARY

Embodiments of this application provide an encoding method, a decoding method, a bitstream, an encoder, a decoder, and a storage medium, thereby improving accuracy of chroma prediction, and improving the coding performance.

The technical solutions in embodiments of this application may be implemented as follows.

According to a first aspect, an embodiment of this application provides a decoding method, applied to a decoder. The method includes:
decoding a bitstream to determine a prediction parameter of a current block and a residual value of a luma component of the current block;
determining a prediction reference block of the current block according to the prediction parameter of the current block, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block;
determining a reconstructed value of the luma component of the current block according to the residual value of the luma component of the current block and the luma prediction reference block;
determining, according to a chroma sample in the chroma prediction reference block, a model reference luma sample set corresponding to the chroma sample;
determining a model parameter of a cross-component prediction model according to the model reference luma sample set, the residual value of the luma component of the current block, and the prediction reference block of the current block;
determining, according to the chroma sample in the chroma prediction reference block, a prediction reference luma sample set corresponding to the chroma sample; and
determining a predicted value of a chroma component of the current block according to the model parameter of the cross-component prediction model, the prediction reference luma sample set, the residual value of the luma component of the current block, and the reconstructed value of the luma component of the current block.

According to a second aspect, an embodiment of this application provides an encoding method, applied to an encoder. The method includes:
determining a prediction reference block of a current block and a residual value of a luma component of the current block according to a prediction parameter of the current block, and writing the prediction parameter of the current block and the residual value of the luma component of the current block into a bitstream, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block;
determining a reconstructed value of the luma component of the current block according to the residual value of the luma component of the current block and the luma prediction reference block;
determining, according to a chroma sample in the chroma prediction reference block, a model reference luma sample set corresponding to the chroma sample;
determining a model parameter of a cross-component prediction model according to the model reference luma sample set, the residual value of the luma component of the current block, and the prediction reference block of the current block;
determining, according to the chroma sample in the chroma prediction reference block, a prediction reference luma sample set corresponding to the chroma sample; and
determining a predicted value of a chroma component of the current block according to the model parameter of the cross-component prediction model, the prediction reference luma sample set, the residual value of the luma component of the current block, and the reconstructed value of the luma component of the current block.

According to a third aspect, an embodiment of this application provides a bitstream, where the bitstream is generated by performing bit encoding on to-be-encoded information. The to-be-encoded information includes at least one of the following:
a prediction parameter of a current block, a residual value of a luma component of the current block, or a chroma format parameter.

According to a fourth aspect, an embodiment of this application provides an encoder, where the encoder includes a first determining unit.

The first determining unit is configured to: determine a prediction reference block of a current block and a residual value of a luma component of the current block according to a prediction parameter of the current block, and writing the prediction parameter of the current block and the residual value of the luma component of the current block into a bitstream, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block; determine a reconstructed value of the luma component of the current block according to the residual value of the luma component of the current block and the luma prediction reference block; determine, according to a chroma sample in the chroma prediction reference block, a model reference luma sample set corresponding to the chroma sample; determine a model parameter of a cross-component prediction model according to the model reference luma sample set, the residual value of the luma component of the current block, and the prediction reference block of the current block; determine, according to the chroma sample in the chroma prediction reference block, a prediction reference luma sample set corresponding to the chroma sample; and determine a predicted value of a chroma component of the current block according to the model parameter of the cross-component prediction model, the prediction reference luma sample set, the residual value of the luma component of the current block, and the reconstructed value of the luma component of the current block.

According to a fifth aspect, an embodiment of this application provides an encoder, where the encoder includes a first memory and a first processor; where
the first memory is configured to store a computer program runnable on the first processor; and
the first processor is configured to execute the method according to the second aspect when running the computer program.

According to a sixth aspect, an embodiment of this application provides a decoder, where the decoder includes a second determining unit.

The second determining unit is configured to decode a bitstream to determine a prediction parameter of a current block and a residual value of a luma component of the current block; determine a prediction reference block of the current block according to the prediction parameter of the current block, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block; determine a reconstructed value of the luma component of the current block according to the residual value of the luma component of the current block and the luma prediction reference block; determine, according to a chroma sample in the chroma prediction reference block, a model reference luma sample set corresponding to the chroma sample; determine a model parameter of a cross-component prediction model according to the model reference luma sample set, the residual value of the luma component of the current block, and the prediction reference block of the current block; determine, according to the chroma sample in the chroma prediction reference block, a prediction reference luma sample set corresponding to the chroma sample; and determine a predicted value of a chroma component of the current block according to the model parameter of the cross-component prediction model, the prediction reference luma sample set, the residual value of the luma component of the current block, and the reconstructed value of the luma component of the current block.

According to a seventh aspect, an embodiment of this application provides a decoder, where the decoder includes a second memory and a second processor.

The second memory is configured to store a computer program runnable on the second processor; and
the second processor is configured to execute the method according to the first aspect when running the computer program.

According to an eighth aspect, an embodiment of this application provides a computer storage medium, where the computer storage medium stores a computer program, and when the computer program is executed, the method in the first aspect or the second aspect is implemented.

### BRIEF DESCRIPTION OF DRAWINGS

FIG. 1 is a schematic diagram of a common InterCCCM framework;

FIG. 2 is a schematic diagram of a prediction procedure of an InterCCCM technology;

FIG. 3 is a schematic diagram 1 of a position relationship between a luma prediction sample and a chroma prediction sample according to an embodiment of this application;

FIG. 4 is a schematic diagram 2 of a positional relationship between a luma prediction sample and a chroma prediction sample according to an embodiment of this application;

FIG. 5 is a schematic diagram 3 of a positional relationship between a luma prediction sample and a chroma prediction sample according to an embodiment of this application;

FIG. 6 is a schematic diagram 1 of a positional relationship between a luma reconstruction sample and a chroma prediction sample according to an embodiment of this application;

FIG. 7 is a schematic diagram 2 of a positional relationship between a luma reconstruction sample and a chroma prediction sample according to an embodiment of this application;

FIG. 8 is a schematic diagram 3 of a positional relationship between a luma reconstruction sample and a chroma prediction sample according to an embodiment of this application;

FIG. 9 is a schematic diagram of a composition of an encoder according to an embodiment of this application;

FIG. 10 is a schematic diagram of a composition of a decoder according to an embodiment of this application;

FIG. 11 is a schematic diagram of a network architecture of a coding system according to an embodiment of this application;

FIG. 12 is a schematic flowchart of a decoding method according to an embodiment of this application;

FIG. 13 is a schematic flowchart of an encoding method according to an embodiment of this application;

FIG. 14 is a schematic structural diagram 1 of an encoder according to an embodiment of this application;

FIG. 15 is a schematic structural diagram 2 of an encoder according to an embodiment of this application;

FIG. 16 is a schematic structural diagram 1 of a decoder according to an embodiment of this application; and

FIG. 17 is a schematic structural diagram 2 of a decoder according to an embodiment of this application.

### DESCRIPTION OF EMBODIMENTS

The following clearly and fully describes the technical solutions in embodiments of this application with reference to the accompanying drawings of embodiments of this application. It may be understood that a specific embodiment described herein is merely used to explain the application, but is not intended to limit the application. In addition, it should be noted that, for ease of description, only a part related to the application is shown in the accompanying drawings.

In the following descriptions, the term “some embodiments” describes a subset of all possible embodiments, but it may be understood that “some embodiments” may be the same subset or different subsets of all possible embodiments and may be combined without a conflict. It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

It may be understood that, in video images, a coding block is generally represented by a first color component, a second color component, and a third color component. The three color components are a luma component, a blue chroma component, and a red chroma component, respectively. Specifically, the luma component is generally denoted by a symbol Y, the blue chroma component is generally denoted by a symbol Cb or U, and the red chroma component is generally denoted by a symbol Cr or V. In this way, a video image may be represented in a YCbCr format or a YUV format.

The universal video coding standard adopts the block-based hybrid encoding framework. Each frame in the video image is partitioned into square largest coding units (Largest Coding Unit, LCU) or coding tree units (Coding Tree Unit, CTU) of the same size (e.g., 128×128, 64×64, etc.), and each largest coding unit or coding tree unit may be further partitioned into rectangular coding units (Coding Unit, CU) according to a rule. In addition, the coding unit may be further partitioned into smaller prediction units (Prediction Unit, PU), transform units (Transform Unit, TU), and the like.

The inter-frame cross-component convolution model InterCCCM is applied to an inter prediction mode and an intra prediction mode. If the current block is encoded by using the inter prediction or intra prediction (e.g., intra block copy (Intra Block Copy, IBC) mode), and by using InterCCCM mode, the encoding side and the decoding side apply a cross-component convolution model (CCCM) to the block to correct chroma samples from reconstructed luma samples. Parameters of the cross-component convolution model are derived from the luma predicted value and the first chroma predicted value. The second chroma predicted value is obtained by using the derived model and the luma reconstructed value. Weighting is performed on the second chroma predicted value and the first chroma predicted value to generate a third chroma predicted value.

FIG. 1 is a schematic diagram of a common InterCCCM framework. As shown in FIG. 1, InputData1, InputData 2, and InputData3 may be PredY, PredCb, or PredCr, or may be PredR, PredG, or PredGB, or may be PredX, PredY, or PredZ, or another representation of different color spaces. ResData1, ResData2 and ResData3 are prediction residuals corresponding to InputData1, InputData 2, and InputData3. OutputData1, OutputData2, and OutputData3 are reconstruction values corresponding to InputData1, InputData 2, and InputData3.

In the weighting module (Weighting), the second chroma predicted value (predCbVal for the Cb component, predCrVal for the Cr component) and the first chroma predicted value (predSamplesCb for the Cb component, predSamplesCr for the Cr component) may be weighted according to 0.75:0.25 to generate a third chroma predicted value (predSamplesCb′ for the Cb component, predSamplesCr′ for the Cr component) . The process is shown by the following formula:

predSamplesCb′=(3×predCbVal+predSamplesCb+2)»2 (1)

Predsamplescr′=(3×predcrval+predsamplescr+2)»2 (2)

The input of the InterCCCM may include a luma predicted value predSamplesY[x][y] of the current block, a luma reconstructed value recSamplesY[x][y], and a first chroma predicted value (predSamplesCb[x1][y1] for the Cb component and predSamplesCr[x1][y1] for the Cr component), where x=0.nTbW−1, y=0 . . . nTbH−1, x1=0 . . . nTbWC−1, and y1=0 . . . nTbHC−1.

The output of the InterCCCM may include a final chroma predicted value of the current block (predSamplesCb′[x][y] for the Cb component and predSamplesCr′ [x][y] for the Cr component), where x=0 . . . nTbWC−1, and y=0 . . . nTbHC−1.

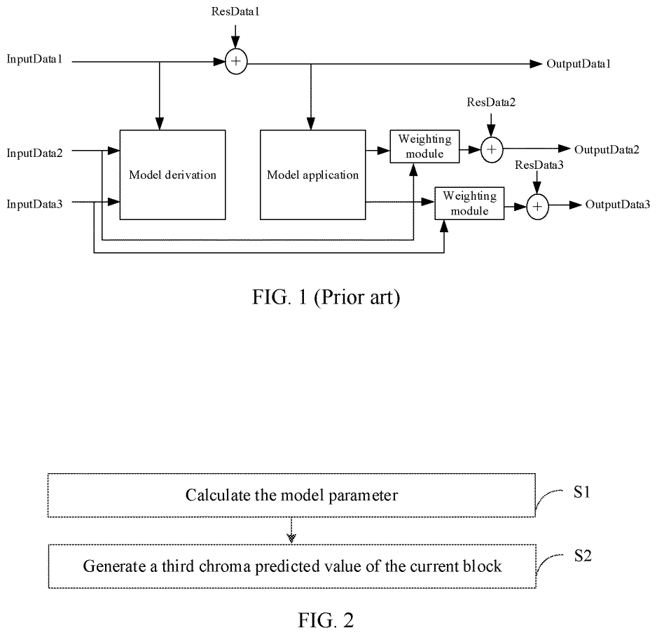

FIG. 2 is a schematic diagram of a prediction procedure of an InterCCCM technology. As shown in FIG. 2, a specific prediction process of the InterCCCM technology includes two steps: S1, solving a model parameter; S2, generating a third chroma predicted value of the current block.

Further, in the process of solving the model parameters, the model used in the InterCCCM technology is an 8-tap filter consisting of 6 spatial luma samples, a non-linear term, and an offset terms. The model is shown by the formula:

predChromaVal=c₀L0′+c₁L1′+c₂L2′+c₃L3′+c₄L4′+c₅L5′+c₆nonlinear((L0′+L3′+1)»1)+c₇B

The nonlinear term nonlinear and the offset term B are determined by using the following formula:

nonlinear(val)=(val×val+(1«(bitdepth−1)))»bitdepth (4)

B=1«(bitdepth−1) (5)

The model parameters c₀~c₇ are obtained by solving an equation, for example, using a division-free Gaussian elimination method.

To reduce the quantity of luma and chroma prediction samples that participate in the model parameter calculation, according to the InterCCCM technology, a down-sampling step dsX and a down-sampling step dsY in x direction and y direction are determined according to the width and the height of the chroma prediction block, so as to perform down-sampling on the chroma prediction block. In the foregoing formula, predChromaVal is a chroma predicted value obtained after down-sampling.

However, according to different picture color formats, the luma prediction sample and the chroma prediction sample may include different position relationships.

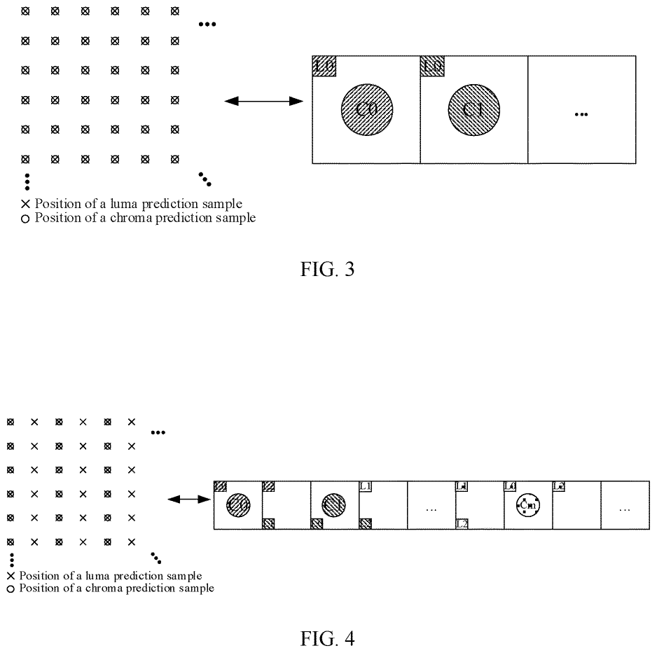

FIG. 3 is a schematic diagram 1 of a positional relationship between a luma prediction sample and a chroma prediction sample according to an embodiment of this application. As shown in FIG. 3, if a picture color format is 4:4:4 colour format, each Y component corresponds to a group of Cb and Cr components. In this case, a luma predicted value L0 corresponding to a position of the first chroma predicted value C is obtained, and a value of L1~L5 is 0.

FIG. 4 is a schematic diagram 2 of a positional relationship between a luma prediction sample and a chroma prediction sample according to an embodiment of this application. As shown in FIG. 4, if a picture color format is 4:2:2 colour format, every two Y components share a group of Cb and Cr components. If the chroma sample position is C0, the luma sample closest to the chroma sample is located at L0 and L2. L0~L2 are obtained. When applied to a calculation formula, a value of L1 is regarded to be equal to L0, and a value of L3~L5 is 0. If the chroma sample position is Cm (m≠0), L0 and luma predicted values L1 and L2 on both sides of L0 are obtained, and a value of L3~L5 is 0. It may be understood that, between adjacent chroma sampling positions, the L2 position corresponding to the left sample corresponds to the L1 position corresponding to the right sample.

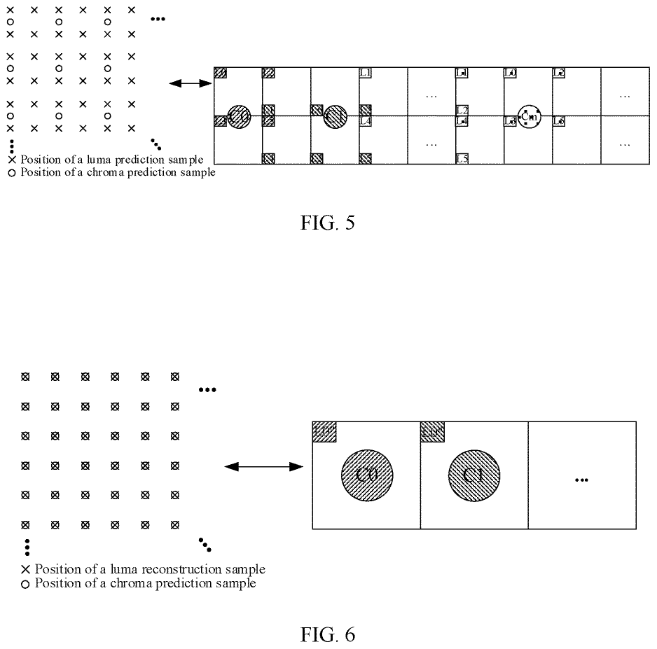

FIG. 5 is a schematic diagram 3 of a positional relationship between a luma prediction sample and a chroma prediction sample according to an embodiment of this application. As shown in FIG. 5, if a picture color format is 4:2:0 colour format, every four Y components share a group of Cb and Cr components. If the chroma sample position is C0, the luma sample closest to the chroma sample is located at L0, L2, L3, and L5. L0~L5 are obtained. When applied to the calculation formula, a value of L1 is regarded to be equal to L0, and a value of L4 is regarded to be equal to L3. If the chroma sample position is Cm (m≠0), L0~L5 are obtained. It may be understood that, between adjacent chroma sampling positions, the L2 position corresponding to the left sample corresponds to the L1 position corresponding to the right sample, and the L5 position corresponding to the left sample corresponds to the L4 position corresponding to the right sample.

During the parameter calculation of the CCCM model, luma and chroma offsets are introduced to reduce the dynamic range of data and bit depth required by the derivation. Both the luma predicted value and the chroma predicted value that participate in the model parameter calculation subtract the luma offset value and the chroma offset value. In the InterCCCM technology, the luma offset value (offsetY) and the chroma offset value (offsetCb for the Cb component and offsetCr for the Cr component) may be simply represented by using an average of pixel values of four vertices of the luma prediction block and the chroma prediction block.

Therefore, L0′~L5′ in the foregoing formula is a difference between L0~L5 (a value is not 0) and the offsetY. The model parameters are obtained by establishing an equation about predChromaVal, L0′~L5′, a non-linear term and an offset term, for example using the Division-free Gaussian elimination method in ECM10.0. OffsetCb and offsetCr also participate in the model parameter calculation.

Further, after the model parameter is solved, the InterCCCM technology generates the second chroma prediction value edChromaVal of the current block by using the following formula:

predChromaVal=c₀L0′+c₁L1′+c₂L2′+c₃L3′+c₄L4′+c₅L5′+c₆nonlinear((L0′+L3′+1)»1)+c₇B

The nonlinear term nonlinear and the offset term B are determined by using the following formula:

nonlinear(val)=(val×val+(1«(bitdepth−1)))»bitdepth (4)

B=1«(bitdepth−1) (5)

The model parameter c₀~c₇ is a model parameter obtained in the previous step. L0′~L5′ is a difference between the luma reconstructed value L0″~L5″ (the value is not 0) and the luma offset value (offsetY).

It should be noted that in embodiments of this application, when the model is applied, the InterCCCM technology does not perform down-sampling on the chroma prediction block. The luma reconstruction samples corresponding to all first chroma prediction values in the chroma prediction block participate in the model application.

However, according to different picture color formats, the luma reconstruction sample and the chroma prediction sample may include different positional relationships.

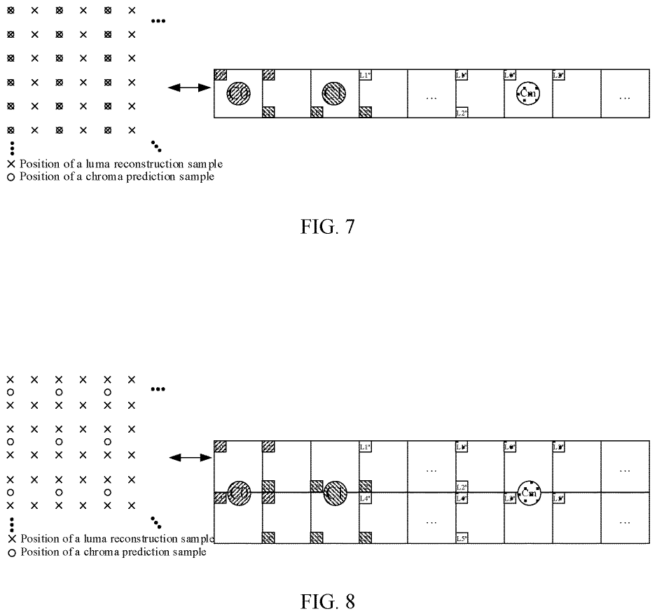

FIG. 6 is a schematic diagram 1 of a positional relationship between a luma reconstruction sample and a chroma prediction sample according to an embodiment of this application. As shown in FIG. 6, if a picture color format is 4:4:4 colour format, each Y component corresponds to a group of Cb and Cr components. In this case, the luma reconstruction value L0″ corresponding to the position of the first chroma predicted value C is obtained, and a value of L1″~L5″ is 0.
FIG. 7 is a schematic diagram 2 of a positional relationship between a luma reconstruction sample and a chroma prediction sample according to an embodiment of this application. As shown in FIG. 7, if a picture color format is 4:2:2 colour format, every two Y components share a group of Cb and Cr components. If the chroma sample is C0, the luma sample closest to the chroma sample is located at L0″ and L2″. L0″~L2″ are obtained. When applied to the calculation formula, a value of L1″ is regarded to be equal to L0″, and a value of L3″~L5″ is 0. If the chroma sample position is Cm (m≠0), L0″ and luma reconstruction values L1″and L2″on both sides of L0″ are obtained, and a value of L3″~L5″ is 0. It may be understood that, between left and right adjacent chroma sampling positions, a position L2″ corresponding to the left sample corresponds to a position L1″corresponding to the right sample.

FIG. 8 is a schematic diagram 3 of a positional relationship between a luma reconstruction sample and a chroma prediction sample according to an embodiment of this application. As shown in FIG. 8, if a picture color format is 4:2:0 colour format, every four Y components share a group of Cb and Cr components. If the chroma sample position is C0, the luma reconstruction sample closest to the chroma sample is located at L0″, L2″, L3″and L5″. L0″~L5″ are obtained. When applied to the calculation formula, a value of L1″ is regarded to be equal to L0″, and a value of L4″ is regarded to be equal to L3″. If the chroma sample postion is Cm (m≠0), L0″~L5″ are obtained. It may be understood that, between left and right adjacent chroma sampling positions, a position L2″ corresponding to the left sample corresponds to a position L1″ corresponding to the right sample, and a position L5″ corresponding to the left sample corresponds to a position L4″ corresponding to the right sample.

In the process of applying the CCCM model, the luma offset is introduced to reduce the dynamic range of the data and bit depth required by the derivation. The luma offset is subtracted from the luma reconstruction value participates in the model application. The luma offset value (offsetY) is simply represented by an average value of pixel values of four vertices of the luma prediction block.

The second chroma prediction value (predCbVal for the Cb component, predCrVal for the Cr component) and the first chroma prediction value (predSamplesCb for the Cb component, predSamplesCr for the Cr component) obtained by using the foregoing formula are weighted by using the following formula, to generate a third chroma prediction value (predSamplesCb′for the Cb component, predSamplesCr′for the Cr component).

predSamplesCr′=w×predCrVal+(1−w)×predSamplesCb (6)

predSamplesCr′=w×predCrVal+(1−w)×predSamplesCr (7)

In which, w represents the weight, for example, w is 0.75.

It can be learned that the InterCCCM technology is mainly used to filter the luma reconstructed value, so as to correct the first chroma prediction value.

However, after the current block is subjected to the inter prediction or the intra prediction, if a residual of a partial luma sample is 0, it indicates that prediction of the partial luma sample of the current block and the chroma sample at a corresponding position are sufficiently accurate. If these luma prediction samples whose residual is 0 participate in the model parameter calculation, it is equivalent to deriving the model parameter for samples whose prediction is not sufficiently accurate by using the samples whose prediction is sufficiently accurate, the derived model cannot accurately reflect a relationship between the luma prediction samples whose prediction is inaccurate and the chroma prediction samples. When the model is applied, the chroma samples with sufficient prediction accuracy are corrected, resulting in that the chroma sample prediction residual becomes larger.

That is, the common InterCCCM technology does not accurately distinguish and select the use of the luma reconstructed values, resulting in reducing of the accuracy of the chroma prediction when the chroma prediction value is corrected by filtering the luma reconstructed values, thus degrading the coding performance.

To resolve the foregoing problem, in embodiments of this application, in a process of determining the model parameter of the cross-component prediction model, the luma sample that participates in model parameter derivation may be screened according to the residual value of the luma component of the current block. In addition, in a process of applying the cross-component prediction model, the luma sample may also be screened according to the residual value of the luma component of the current block. Therefore, in a process of model derivation and application, whether to use the luma prediction sample may be determined according to prediction accuracy of the luma prediction sample, so that a model parameter that can more accurately reflect a relationship between the luma prediction sample and the chroma prediction sample may be obtained. At the same time, a better correction effect may be obtained, thereby improving accuracy of the chroma prediction, and further improving the coding performance.

The following describes embodiments of this application in detail with reference to the accompanying drawings.

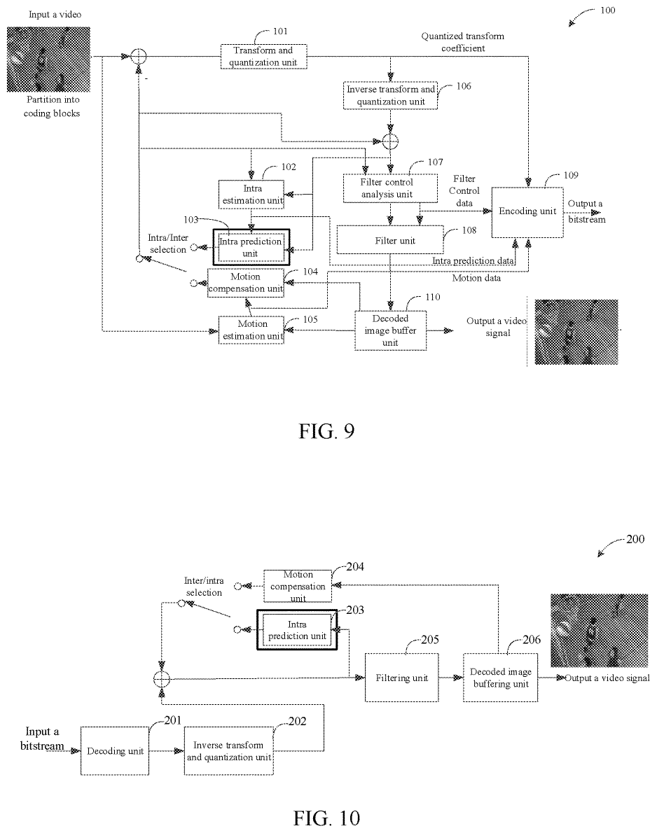

Reference is made to FIG. 9, which shows a schematic diagram of composition of an encoder according to an embodiment of this application. As shown in FIG. 9, an encoder (specifically “video encoder”) 100 may include a transform and quantization unit 101, an intra estimation unit 102, an intra prediction unit 103, a motion compensation unit 104, a motion estimation unit 105, an inverse transform and quantization unit 106, a filter control analysis unit 107, a filtering unit 108, an encoding unit 109, a decoded image buffer unit 110, and the like. The filtering unit 108 may implement de-blocking filtering and Sample Adaptive offset (Sample Adaptive offset, SAO) filtering, and the encoding unit 109 may implement header information encoding and context-based adaptive binary arithmetic coding (Context-based Adaptive Binary Arithmetic Coding, CABAC). For an input original video signal, a video coding block may be obtained by dividing a coding tree unit (Coding Tree Unit, CTU), and then the video coding block is transformed by the transform and quantization unit 101 based on residual pixel information obtained after intra or inter prediction, including transforming residual information from a pixel field to a transform field, and performing quantization on the obtained transform coefficient, so as to further reduce a bit rate. The intra estimation unit 102 and the intra prediction unit 103 are configured to perform intra prediction on the video coding block. Specifically, the intra estimation unit 102 and the intra prediction unit 103 are configured to determine an intra prediction mode to be used to encode the video coding block. The motion compensation unit 104 and the motion estimation unit 105 are configured to execute inter prediction encoding on the received video coding block relative to one or more blocks of one or more reference frames to provide time prediction information. The motion estimation executed by the motion estimation unit 105 is a process of generating a motion vector, and the motion vector may estimate a motion of the video coding block, and then the motion compensation unit 104 executes the motion compensation based on the motion vector determined by the motion estimation unit 105. After determining the intra prediction mode, the intra prediction unit 103 is further configured to provide the selected intra prediction data to the encoding unit 109, and the motion estimation unit 105 also transmits the calculated motion vector data to the encoding unit 109. In addition, the inverse conversion and quantization unit 106 is configured to reconstruct the video coding block, reconstruct the residual block in the pixel domain, and the reconstructed residual block is processed by the filter control analysis unit 107 and the filter unit 108 to remove blocking effect. Then, the reconstructed residual block is added to predictive block in a frame of the decoded picture buffer unit 110 to generate a reconstructed video coding block. The encoding unit 109 is used to encode various encoding parameters and quantized transform coefficients. In the CABAC-based encoding algorithm, the context content may be based on adjacent coding blocks and may be used to encode information indicating the determined intra prediction mode, a bitstream of the video signal is outputted. The decoded picture buffer unit 110 is configured to store the reconstructed video coding block for prediction reference. As video picture encoding proceeds, new reconstructed video coding blocks are continuously generated, and these reconstructed video coding blocks are all stored in the decoded picture buffer unit 110.

Reference is made to FIG. 10, which shows a schematic diagram of composition of a decoder according to an embodiment of this application. As shown in FIG. 10, a decoder (specifically “video decoder”) 200 includes a decoding unit 201, an inverse transform and quantization unit 202, an intra prediction unit 203, a motion compensation unit 204, a filtering unit 205, a decoded picture buffer unit 206, and the like. The decoding unit 201 may implement header information decoding and CABAC decoding, and the filtering unit 205 may implement deblocking filtering and SAO filtering. After the input video signal is subjected to the encoding processing in FIG. 8, a bitstream of the video signal is outputted. The bitstream is input to the decoder 30, and is processed first by the decoding unit 201 to obtain decoded transform coefficients. The transform coefficients are processed by the inverse transform and quantization unit 202 to generate a residual block in the pixel domain. The intra prediction unit 203 may be used to generate prediction data for a current video decoding block based on the determined intra prediction mode and data from a previously decoded block of the current frame or picture. The motion compensation unit 204 determines prediction information for the video decoding block by parsing motion vectors and other associated syntax elements, and uses the prediction information to generate a predictive block for the video decoding block being decoded. A decoded video block is formed by summing the residual block from the inverse transform and quantization unit 202 and the corresponding predictive block generated by the intra prediction unit 203 or the motion compensation unit 204. The decoded video signal is processed by the filtering unit 205 to remove block effect artifacts, thereby improving video quality. The decoded video block is then stored in the decoded picture buffer unit 206. The decoded picture buffer unit 206 stores reference pictures for subsequent intra prediction or motion compensation, and is also used for outputting the video signal, thereby obtaining the restored original video signal.

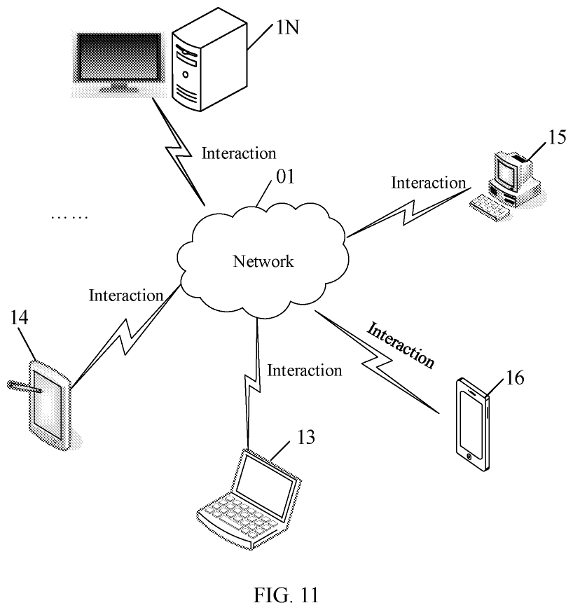

Further, an embodiment of this application further provides a network architecture of a coding system that includes an encoder and a decoder. FIG. 11 shows a schematic diagram of a network architecture of a coding system according to an embodiment of this application. As shown in FIG. 11, the network architecture includes one or more electronic devices 13 to 1N and a communications network 01, where the electronic devices 13 to 1N may perform video interaction by using the communications network 01. The electronic device may be implemented as various types of devices that have a video coding function. For example, the electronic device may include a smartphone, a tablet computer, a personal computer, a personal digital assistant, a navigator, a digital telephone, a video telephone, a television, a sensing device, and a server and so on. This is not specifically limited in embodiments of this application. Here, the decoder or the encoder described in embodiments of this application may be the electronic device described above.

It should be noted that the method in embodiments of this application is mainly applied to the intra prediction unit 103 and the motion compensation unit 104 shown in FIG. 9, and the intra prediction unit 203 and the motion compensation unit 204 shown in FIG. 10. That is, embodiments of this application may be applied to either an encoder or a decoder, or may even be applied to both an encoder and a decoder. However, embodiments of this application set no specific limitation thereto.

It should be further noted that “the current block” specifically refers to the encoding block currently to be predicted, or refers to the decoding block currently to be predicted.

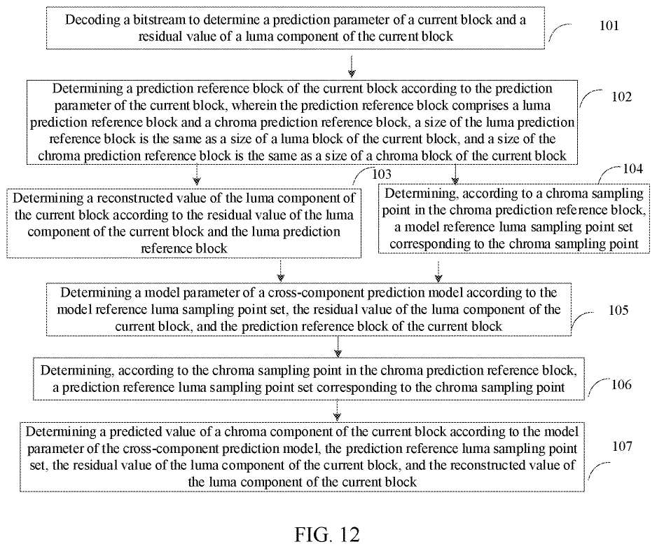

An embodiment of this application provides a decoding method. The decoding method is applied to a decoder. FIG. 12 is a schematic flowchart of a decoding method according to an embodiment of this application. As shown in FIG. 12, the method for performing decoding processing by the decoder may include the following steps 101 to 107.

In step 101, a bitstream is decoded to determine a prediction parameter of a current block and a residual value of a luma component of the current block.

In embodiments of this application, the bitstream may be decoded first to determine the prediction parameter corresponding to the current block, and the residual value of the luma component of the current block may also be determined.

It should be noted that the decoding method in embodiments of this application is applied to a decoder. In addition, the decoding method may include a prediction method, and more specifically, a picture component prediction method. The video picture may be divided into multiple decoding blocks, and each decoding block may include a first color component, a second color component, and a third color component. In embodiments of this application, the current block refers to a decoding block currently to be predicted in the video picture.

Herein, when the first color component needs to be predicted, the to-be-predicted component is the first color component; when the second color component needs to be predicted, the to-be-predicted component is the second color component; and when the third color component needs to be predicted, the to-be-predicted component is the third color component. In addition, assuming that a first color component of the current block is to be predicted, and the first color component is a luma component, that is, the to-be-predicted component is the luma component, the current block may also be referred to as a luma block. Alternatively, assuming that a second color component of the current block is to be predicted, and the second color component is a chroma component, that is, the to-be-predicted component is the chroma component, the current block may also be referred to as a chroma block.

It should be noted that, in embodiments of this application, the prediction parameter corresponding to the current block may be used to determine a prediction block of the luma component and a prediction block of the chroma component corresponding to the current block.

It may be understood that, in embodiments of this application, the prediction parameter of the current block may be used to determine a parameter of a prediction manner used when the current block is predicted.

For example, in some embodiments, the prediction parameter of the current block may include at least one of the following parameters: an inter prediction parameter, an intra block copy (IBC) parameter, an inter template matching parameter, or an intra template matching parameter.

It should be noted that in embodiments of this application, the prediction parameter of the current block may further include other parameters and information of any type, and the prediction parameter of the current block is not specifically limited in this application.

In step 102, a prediction reference block of the current block is determined according to a prediction parameter of the current block, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block.

In embodiments of this application, after the prediction parameter of the current block is determined by decoding the bitstream, the prediction reference block of the current block may be further determined according to the prediction parameter of the current block.

It should be noted that in embodiments of this application, the prediction reference block of the current block may include a luma prediction reference block corresponding to the luma component and a chroma prediction reference block corresponding to the chroma component.

That is, in embodiments of this application, the luma component and the chroma component of the current block may be separately predicted based on the prediction parameter, so that the corresponding luma prediction reference block and chroma prediction reference block may be determined, that is, the prediction reference block of the current block is determined.

It should be noted that in embodiments of this application, when determining the prediction reference block of the current block according to the prediction parameter of the current block, the prediction reference block of the current block may be determined based on the inter prediction parameter by using the inter prediction. That is, inter prediction may be separately performed on the luma component and the chroma component of the current block based on the inter prediction parameter, so that the corresponding luma prediction reference block and chroma prediction reference block may be determined.

It should be noted that in embodiments of this application, when the prediction reference block of the current block is determined according to the prediction parameter of the current block, the prediction reference block of the current block may be determined based on an IBC parameter by using the IBC. That is, the IBC prediction may be separately performed on the luma component and the chroma component of the current block based on the IBC parameter, so that the corresponding luma prediction reference block and chroma prediction reference block may be determined.

It should be noted that, in embodiments of this application, when the prediction reference block of the current block is determined according to the prediction parameter of the current block, the prediction reference block of the current block may be determined based on an inter template matching parameter by using the inter template matching. That is, the inter template matching prediction may be separately performed on the luma component and the chroma component of the current block based on the inter template matching parameter, so that the corresponding luma prediction reference block and chroma prediction reference block may be determined.

It should be noted that in embodiments of this application, when determining the prediction reference block of the current block according to the prediction parameter of the current block, the prediction reference block of the current block is determined based on an intra template matching parameter by using the intra template matching. That is, the intra template matching prediction may be separately performed on the luma component and the chroma component of the current block based on the intra template matching parameter, so that the corresponding luma prediction reference block and chroma prediction reference block may be determined.

For example, in some embodiments, based on the prediction parameters of the current block, the prediction reference block may also be obtained using any of the following methods: the inter/BV-based prediction in GPM, the inter/BV-based prediction block in CIIP, etc.

Further, in embodiments of this application, a size of the luma prediction reference block is the same as a size of the luma block of the current block, and a size of the chroma prediction reference block is the same as a size of the chroma block of the current block.

That is, in embodiments of this application, the prediction reference block determined by using the prediction parameter is equal to the current block in size.

In step 103, a reconstructed value of the luma component of the current block is determined according to the residual value of the luma component of the current block and the luma prediction reference block.

In embodiments of this application, after decoding the bitstream to determine the prediction parameters of the current block and the residual value of the luma component of the current block, and determining the luma prediction reference block of the current block based on the prediction parameters, the reconstructed value of the luma component of the current block may be further determined based on the residual value of the luma component of the current block and the luma prediction reference block.

It should be noted that in embodiments of this application, when determining the reconstructed value of the luma component of the current block according to the residual value of the luma component of the current block and the luma prediction reference block, a sum of the residual value of the luma component of the current block and the prediction value corresponding to the luma prediction reference block may be determined as the reconstructed value of the luma component of the current block.

In step 104, according to a chroma sample in the chroma prediction reference block, a model reference luma sample set corresponding to the chroma sample is determined.

In embodiments of this application, after decoding the bitstream to determine the prediction parameters of the current block, and determining the prediction reference block of the current block including the luma prediction reference block and the chroma prediction reference block based on the prediction parameters, a set of model reference luma samples corresponding to the chroma sample may be further determined based on the chroma sample in the chroma prediction reference block.

It should be noted that in embodiments of this application, when the chroma sample is selected from the chroma prediction reference block, all samples in the chroma prediction reference block may be selected as the chroma sample, or some of the samples in the chroma prediction reference block may be selected by using a downsampling manner as the chroma sample.

It may be understood that in embodiments of this application, to reduce a quantity of luma and chroma prediction samples (that is, a quantity of chroma samples and a quantity of luma samples) that participate in model parameter calculation, downsampling may be first performed on the chroma prediction block, so that the chroma sample is determined from the chroma prediction block.

Further, in embodiments of this application, a downsampling step may be first determined according to a size parameter of the chroma prediction reference block. Then, the chroma prediction reference block is downsampled according to the downsampling step to determine the chroma sample.

It should be noted that in embodiments of this application, a downsampling step dsX and a downsampling step dsY in the x direction and the y direction are first determined according to the chroma prediction reference block width and height, so that downsampling may be performed on the chroma prediction reference block by using the downsampling step, and finally a downsampled chroma prediction value, that is, a chroma sample, is obtained.

It may be understood that in embodiments of this application, the model reference luma sample set determined based on the chroma sample may include the luma sample used for model parameter derivation.

It should be noted that in embodiments of this application, the chroma sample may be some or all samples in the chroma prediction reference block. Correspondingly, the luma sample may also be some or all samples in the luma prediction reference block that correspond to the chroma sample. The correspondence between the chroma sample and the luma sample may be determined based on a chroma format parameter of the current block.

That is, in embodiments of this application, the chroma sample that is used to determine the model parameter of the cross-component prediction model may be all samples in the chroma prediction reference block, or may be some samples in the chroma prediction reference block, which is not specifically limited in this application.

Further, in embodiments of this application, when determining, according to the chroma sample in the chroma prediction reference block, the model reference luma sample set corresponding to the chroma sample, the chroma format parameter may be first determined. Then, the luma sample corresponding to the chroma sample may be determined in the luma prediction reference block according to the chroma format parameter and the chroma sample in the chroma prediction reference block. Finally, the model reference luma sample set may be determined according to the luma sample.

It should be noted that in embodiments of this application, the bitstream may be decoded to determine the chroma format parameter, and further, the chroma format of the current block may be determined according to the chroma format parameter.

It may be understood that, in embodiments of this application, the chroma format parameter may be used to indicate a chroma format corresponding to the current block. The chroma format may be a picture color format, and may include 4:4:4, 4:2:2, and 4:2:0.

Exemplarily, in some embodiments, the chroma format parameter may be represented by using sps_chroma_format_idc. When a value of the chroma format parameter is a first value, it is determined that the current block is of the first chroma format; when the value of the chroma format parameter is a second value, it is determined that the current block is of the second chroma format; or when the value of the chroma format parameter is a third value, it is determined that the current block is of the third chroma format.

It should be noted that in embodiments of this application, the first value, the second value, and the third value are different, and the first value, the second value, and the third value may be in a parameter form, or may be in a digital form. Specifically, the chroma format parameter may be a parameter written in the parameter set, or may be a value of a flag (flag), which is not specifically limited herein.

In addition, for the first value, the second value, and the third value, the first value may be set to 0, the second value may be set to 1, and the third value may be set to 2. Alternatively, the first value may be set to 2, the second value may be set to 1, and the third value may be set to 0. In embodiments of this application, the first value is set to 0, the second value is set to 1, and the third value is set to 2, which is not specifically limited.

It should be noted that in embodiments of this application, the first chroma format may be 4:4:4, the second chroma format may be 4:2:2, and the third chroma format may be 4:2:0.

Further, in embodiments of this application, when the luma sample corresponding to the chroma sample is determined in the luma block of the current block according to the chroma format parameter and the chroma sample in the chroma block of the current block, related luma coordinates may be first determined in the luma prediction reference block according to the chroma format parameter and chroma sample coordinates in the chroma prediction reference block. Then, the sample corresponding to the related luma coordinates may be determined as the luma sample corresponding to the chroma sample.

It may be understood that, in embodiments of this application, the related luma coordinates may be coordinates that are in the luma prediction reference block and that correspond to coordinates of the chroma sample. The correspondence between the coordinates may be determined by using the chroma format parameter. Based on different chroma format parameters, the finally determined related luma coordinates are different.

For example, in some embodiments, chroma sample coordinates of the chroma sample may be (xC, yC).

Correspondingly, in embodiments of this application, when the related luma coordinates are determined in the luma prediction reference block according to the chroma format parameter and the chroma sample coordinates of the chroma sample in the chroma prediction reference block, the related luma coordinates (xY, yY) determined in the luma prediction reference block according to the chroma sample coordinates (xC, yC) may include first coordinates L0 (xC, yC), if the current block is of the first chroma format.

It may be understood that, in embodiments of this application, for the first chroma format 4:4:4, each Y component corresponds to a group of Cb and Cr components. In this case, the first coordinates L0 (xC, yC) corresponding to the same position as the coordinates of the chroma sample may be obtained in the luma prediction reference block as the related luma coordinates, that is, the sample of the first coordinates L0 (xC, yC) in the luma prediction reference block is the corresponding luma sample.

That is, in embodiments of this application, in a case in which the current block is of the first chroma format, the determined model reference luma sample set includes a luma sample of first coordinates L0 (xC, yC) corresponding to the chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, and when the current block is of the second chroma format, the related luma coordinates (xY, yY) determined in the luma prediction reference block according to the chroma sample coordinates (xC, yC) includes second coordinates L1 (xC<<1, yC), third coordinates L2 (xC<<1−1, yC), and fourth coordinates L3 (xC<<1+1, yC).

It may be understood that, in embodiments of this application, for the second chroma format 4:2:2, every two Y components share one group of Cb and Cr components. If the coordinates of the chroma sample are (xC, yC), the related luma coordinates corresponding to the coordinates of the chroma sample in the luma prediction reference block are the second coordinates L1 (xC<<1, yC), the third coordinates L2 (xC<<1−1, yC), and the fourth coordinates L3 (xC<<1+1, yC), that is, the samples having the second coordinates L1 (xC<<1, yC), the third coordinates L2 (xC<<1−1, yC), and the fourth coordinates L3 (xC<<1 +1, yC) in the luma prediction reference block are corresponding luma samples.

That is, in embodiments of this application, in a case in which the current block is of a second chroma format, the determined model reference luma sample set includes luma samples having second coordinates L1 (xC<<1, yC), third coordinates L2 (xC<<1−1, yC), and fourth coordinates L3 (xC<<1+1, yC) that correspond to the chroma sample coordinates (xC, yC).

Correspondingly, in embodiments of this application, when the related luma coordinates are determined in the luma prediction reference block according to the chroma format parameter and the coordinates of the chroma sample in the chroma prediction reference block, and when the current block is of a third chroma format, the related luma coordinates (xY, yY) determined in the luma prediction reference block according to the chroma sample coordinates (xC, yC) includes: fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1).

It may be understood that, in embodiments of this application, for the third chroma format 4:2:0, every four Y components share one group of Cb and Cr components. If the coordinates of the chroma sample are (xC, yC), the related luma coordinates corresponding to the coordinates of the chroma sample in the luma prediction reference block are the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), the tenth coordinates L9 (xC<<1+1, yC<<1+1), that is, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) in the luma prediction reference block are corresponding luma samples.

That is, in embodiments of this application, in a case in which the current block is of a third chroma format, the determined model reference luma sample set includes luma samples having fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1) that correspond to chroma sample coordinates (xC, yC).

It should be noted that, in embodiments of this application, <<is a left shift operator, where m<<n indicates that an operation of a left shift by n bits is performed on a binary number of m, a result of m<<n is m×2ⁿ, and m and n are integers greater than 0.

That is, in embodiments of this application, the luma sample includes a co-located sample of the chroma sample in the luma prediction reference block, and/or a sample adjacent to the co-located sample.

For example, in some embodiments, the luma sample may include a co-located sample of the chroma sample in the luma prediction reference block, such as a sample having coordinates (xY, yY), and/or a sample that is adjacent to the co-located sample, such as samples having coordinates (xY−1, yY), (xY+1, yY), (xY, yY+1), (xY−1, yY+1), and (xY+1, yY+1).

In step 105, a model parameter of a cross-component prediction model is determined according to the model reference luma sample set, a residual value of the luma component of the current block, and a prediction reference block of the current block.

In embodiments of this application, after determining the model reference luma sample set corresponding to the chroma samples based on the chroma samples in the chroma prediction reference block, the model parameters of the cross-component prediction model may be further determined based on the model reference luma sample set, the residual value of the luma component of the current block, and the prediction reference block of the current block.

It should be noted that in embodiments of this application, after determining the chroma sample that is used to derive the model parameter of the cross-component prediction model and the corresponding model reference luma sample set, the luma sample and the chroma sample may be further screened with reference to the residual value of the luma component of the current block, and the model parameter of the cross-component prediction model is further determined by using the screened sample whose residual value meets a requirement.

Further, in embodiments of this application, when the model parameter of the cross-component prediction model is determined according to the model reference luma sample set, the residual value of the luma component of the current block, and the prediction reference block of the current block, a first availability parameter of the luma sample in the model reference luma sample set may be first determined according to the residual value of the luma component of the current block. Then, the model parameter of the cross-component prediction model may be determined according to the first availability parameter and the prediction reference block of the current block.

It should be noted that, in embodiments of this application, the first availability parameter may be used to indicate whether to use the luma sampling value of the luma sample. For a luma sample, if a corresponding first availability parameter indicates “available”, it may be understood that a luma sampling value of the luma sample is used. If the corresponding first availability parameter indicates “unavailable”, it may be understood that the luma sampling value of the luma sample is not used.

Further, in embodiments of this application, when the first availability parameter of the luma sample in the model reference luma sample set is determined according to the residual value of the luma component of the current block, in a case in which the residual value of the luma component of the current block corresponding to the luma sample meets the first condition, the first availability parameter of the luma sample indicates that the luma sampling value of the luma sample is not used. In a case in which the residual value of the luma component of the current block corresponding to the luma sample does not meet the first condition, the first availability parameter of the luma sample indicates that the luma sampling value of the luma sample is used.

It should be noted that, in embodiments of this application, for a luma sample, a residual value of the luma component of the current block at the luma sampling coordinates of the luma sample, i.e., a value corresponding to the luma sample, may be determined first, and then it is determined whether the residual value at the luma sampling coordinates meets a first condition. If the residual value meets the first condition, the first availability parameter of the luma sample is determined as “unavailable”, that is, it indicates that the luma sampling value of the luma sample is not used. Otherwise, the first availability parameter of the luma sample is determined as “available”, that is, it indicates that the luma sampling value of the luma sample is used.

It may be understood that, in embodiments of this application, the first condition may be used to distinguish and screen the residual value with reference to a preset first residual threshold. The first condition may include: a residual value of the luma component of the current block corresponding to a luma sample is less than or equal to the first residual threshold.

It should be noted that in embodiments of this application, a value of the first residual threshold may be any preset value. For example, the first residual threshold may be 0, or may be 4.

That is, in embodiments of this application, when the first availability parameter is determined for the luma reference point, the residual value of the luma component corresponding to the luma sample may be compared with the first residual threshold. If a comparison result is that the residual value of the luma component corresponding to the luma sample is less than or equal to the first residual threshold, it may be determined that the luma prediction accuracy of the luma sample is relatively high. It may be considered that the model parameter obtained by deriving by using the luma sampling value of the luma sample is not applicable to the luma sample with low prediction accuracy. Therefore, the luma sampling value of the luma sample may be not selected, that is, the first availability parameter of the luma sample indicates that the luma sample is not used.

Correspondingly, in embodiments of this application, if the comparison result is that the residual value of the luma component corresponding to the luma sample is greater than the first residual threshold, it may be determined that the luma prediction accuracy of the luma sample is relatively low. It may be considered that the model parameter obtained by deriving by using the luma sampling value of the luma sample may be applicable to a sample with low prediction accuracy. Therefore, the luma sampling value of the luma sample may be used, that is, it may be determined that the first availability parameter of the luma sample indicates that the luma sampling value of the luma sample is used.

It should be noted that, in embodiments of this application, the first availability parameter may be determined by comparing the residual value of the luma component corresponding to the luma sample with the first residual threshold, or the first availability parameter may be determined in any other manner. For example, the residual value of the luma component corresponding to the luma sample is shifted right by 2 bits, and then compared with the first residual threshold.

Exemplarily, in some embodiments, assuming that the first residual threshold is 0. The luma sample is screened according to the residual value of the luma component of the current block. If the residual value of the luma component of the current block corresponding to the luma sample is 0, that is, is less than or equal to the first residual threshold, the model parameter is not derived by using the luma sampling value of the luma sample. If the residual value of the luma component of the current block corresponding to the luma sample is not 0, that is, is greater than the first residual threshold, the model parameter is derived by using the luma sampling value of the luma sample.

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value, the chroma sampling value, a nonlinear term, and/or an offset term.

It should be noted that, in embodiments of this application, the cross-component prediction model may include InterCCCM. The cross-component prediction model may be an 8-tap filter including six spatial luma samples, the non-linear term, and the offset term, such as the foregoing formula (3).

Exemplarily, in some embodiments, for a chroma sample, if a residual value of a luma sample corresponding to the chroma sample (that is, a luma residual of the luma component of the current block corresponding to the luma sample) is greater than a first residual threshold, that is, a first availability parameter corresponding to the luma sample indicates that a model parameter may be derived by using the luma sampling value of the luma sample, a luma sampling value corresponding to the luma sample may be determined according to the luma prediction reference block, and a chroma sampling value corresponding to the chroma sample may be determined according to the chroma prediction reference block. Then, based on the foregoing formulas (4) and (5), a model parameter c₀~c₇ is determined with reference to the nonlinear term and/or the offset term. In which, the model parameter c₀~c₇ may be obtained by solving the equation, for example, using a division-free Gaussian elimination method.

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample is determined according to the luma prediction reference block, and the chroma sampling value corresponding to the chroma sample is determined according to the chroma prediction reference block. Then, the model parameter of the cross-component prediction model is determined according to the luma sampling value, the chroma sampling value, and the offset term. That is, in a process of determining the model parameter, the non-linear term may not be used.

It should be noted that, in embodiments of this application, the cross-component prediction model may include InterCCCM. The cross-component prediction model may be an 8-tap filter including six spatial luma samples and an offset term, as shown by the following formula:

predChromaVal=c0L0′+c₁L1′+c₂L2′+c₃L3′+c₄L4′+c₅L5′+c₆((L0′+L3′+1)»1)+c₇B (8)

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value, the chroma sampling value, and the non-linear term. That is, in a process of determining the model parameter, the offset term may not be used.

It should be noted that, in embodiments of this application, the cross-component prediction model may include InterCCCM. The cross-component prediction model may be an 8-tap filter including six spatial luma samples and an offset term, as shown by the following formula:

predChromaVal=c0L0′+c₁L1′+c₂L2′+c₃L3′+c₄L4′+c₅L5′+c₆nonlinear ((L0′+L3′+1)»1)+c₇ (9)

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value and the chroma sampling value. That is, in a process of determining the model parameter, the offset term and the non-linear term may not be used.

That is, in embodiments of this application, the model parameter of the cross-component prediction model may be determined without using the offset term and the non-linear term.

It should be noted that, in embodiments of this application, the cross-component prediction model may include InterCCCM. The cross-component prediction model may be an 8-tap filter including six spatial luma samples and an offset term, as shown by the following formula:

Predchromaval=c₀L0′+c₁L1′+c₂L2′+c₃L3′+c₄L4′+c₅L5′+c₆((L0′+L3′+1)»1)+c₇ (10)

Further, in embodiments of this application, when determining, according to the luma prediction reference block, the luma sampling value corresponding to the luma sample, a luma predicted value of the luma prediction reference block corresponding to the luma sample may be determined as the luma sampling value. Alternatively, in a case in which the luma predicted value of the luma prediction reference block corresponding to the luma sample is not 0, the luma sampling value may be determined according to the luma offset value and the luma predicted value.

Further, in embodiments of this application, when the chroma sampling value corresponding to the chroma sample is determined according to the chroma prediction reference block, the chroma predicted value of the chroma sample corresponding to the chroma prediction reference block may be determined as the chroma sampling value. Alternatively, the chroma sampling value may be determined according to the chroma offset value and the chroma predicted value of the chroma sample corresponding to the chroma prediction reference block.

It may be understood that in embodiments of this application, in a process of calculating a model parameter, to reduce a dynamic range of data and bit depth required by the derivation, a luma offset value and a chroma offset value may be introduced.

For example, in some embodiments, the luma offset value may be subtracted from the luma predicted value participating in the model parameter calculation, so as to obtain a corresponding luma sampling value, and then the model parameter is calculated by using the luma sampling value.

For example, in some embodiments, the chroma offset value may be subtracted from the chroma predicted value participating in the model parameter calculation, so as to obtain a corresponding chroma sampling value, and then the model parameter is calculated by using the chroma sampling value.

It should be noted that in embodiments of this application, the luma offset value (offsetY) and the chroma offset value (offsetCb for the Cb component and offsetCr for the Cr component) may be simply represented by an average value of the four vertex pixel values of the luma prediction block and the chroma prediction block.

It may be understood that, in embodiments of this application, the offset value may not be applied to a calculation process of the model parameter, that is, the luma offset value (offsetY) and the chroma offset value (offsetCb for the Cb component and offsetCr for the Cr component) may not be introduced.

That is, in embodiments of this application, in a process of calculating the model parameter, the finally used luma sampling value L0′~L5′ is a difference between the luma predicted value L0~L5 (the value is not 0) corresponding to the luma sample and the luma offset value offsetY, and finally, an equation between the chroma sampling value predChromaVal and L0′~L5′, the nonlinear term as well as the offset term is established, and the model parameter c₀~c₇ may be obtained by using, for example, a division-free Gaussian elimination method in ECM10.0.

It should be noted that, in embodiments of this application, for different chroma formats indicated by different chroma format parameters, the chroma sample may correspond to different quantities of luma samples. For example, for the first chroma format 4:4:4, one chroma sample corresponds to one luma sample. For the second chroma format 4:2:2, one chroma sample corresponds to three luma samples. For the third chroma format 4:2:0, one chroma sample corresponds to six luma samples. That is, the chroma sample corresponds to at least one luma sample. In a process of determining the first availability parameter of the luma sample, the first availability parameter may be determined based on some or all of the at least one luma sample. This is not specifically limited in this application.

That is, in embodiments of this application, for the at least one luma sample, in a case in which a residual value corresponding to any one of the luma samples is less than or equal to a first residual threshold, it is determined that the first availability parameter corresponding to all the luma samples indicates “unavailable”.

Correspondingly, in embodiments of this application, for the at least one luma sample, in a case in which residual values corresponding to all the luma samples are less than or equal to the first residual threshold, it is determined that the first availability parameters corresponding to all the luma samples indicate “unavailable”.

Exemplarily, in some embodiments, assuming that the first residual threshold is 0. For the first chroma format 4:4:4, each Y component corresponds to a group of Cb and Cr components. In this case, a sample having the first coordinates L0 (xC, yC) co-located with the chroma sample coordinates in the luma prediction reference block may be determined as the corresponding luma sample. If the residual value of the luma component of the current block corresponding to the luma sample L0 (xC, yC) is 0, it may be considered that the first availability parameter corresponding to the luma sample represents “unavailable”. Therefore, neither the chroma sampling value of the (xC, yC) position nor the luma sampling value of the corresponding first coordinates L0 (xC, yC) position participates in the model parameter calculation.

Exemplarily, in some embodiments, assuming that the first residual threshold is 0. For the second chroma format 4:2:2, every two Y components share a group of Cb and Cr components. In this case, samples having the second coordinates L1 (xC<<1, yC), the third coordinates L2 (xC<<1−1, yC), and the fourth coordinates L3 (xC<<1+1, yC) that are co-located with the chroma sample coordinates in the luma prediction reference block may be determined as the corresponding luma sample. If the residual value of the luma component of the current block corresponding to the luma sample L1 (xC<<1, yC) is 0, it may be considered that the first availability parameter corresponding to all the luma samples indicates “unavailable”. Therefore, neither the chroma sampling value of the (xC, yC) position nor the luma sampling value of the corresponding second coordinates L1 (xC<<1, yC), third coordinates L2 (xC<<1−1, yC), and fourth coordinates L3 (xC<<1+1, yC) position participate in the model parameter calculation.

Exemplarily, in some embodiments, assuming that the first residual threshold is 0. For the third chroma format 4:2:0, every four Y components share a group of Cb and Cr components. In this case, luma samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) that are co-located with the chroma sample coordinates in the luma prediction reference block may be determined as the corresponding luma samples. If the residual value of the luma component of the current block corresponding to the luma sample L4 (xC<<1, yC<<1) is 0, it may be considered that the first availability parameter corresponding to all luma samples represents “unavailable”. Therefore, the chroma sampling value at the (xC, yC) position and the luma sampling value at the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) do not participate in the model parameter calculation.

It may be understood that, in embodiments of this application, when determining samples not participating in the model parameter calculation and/or the model application, the samples may be determined not only according to the luma residual value corresponding to the L0 location, but also according to multiple residual values in the L0~L5. For example, the samples may be determined according to L0 and L1, L0 and L3, or L0~L2. Alternatively, the samples may be determined according to the chroma residual value of the position corresponding to the chroma sample being 0.

It should be noted that, in embodiments of this application, if the first availability parameters corresponding to all the luma samples in the model reference luma sample set indicate “unavailable”, the luma sample and the chroma sample are no longer screened and distinguished, but the model parameter is derived by using the chroma sampling value of the chroma sample and the luma sampling value of the luma sample.

In step 106, according to the chroma sample in the chroma prediction reference block, a prediction reference luma sample set corresponding to the chroma sample is determined.

In embodiments of this application, after decoding the bitstream to determine the prediction parameters of the current block, and determining the prediction reference block of the current block including the luma prediction reference block and the chroma prediction reference block based on the prediction parameters, the prediction reference luma sample set corresponding to the chroma samples may be further determined based on the chroma samples in the chroma prediction reference block.

It should be noted that in embodiments of this application, in an application process of the cross-component prediction model, when the chroma sample is selected from the chroma prediction reference block, all samples in the chroma prediction reference block may be selected as the chroma sample.

That is, in the embodiments of this application, when the model parameter of the cross-component prediction model is determined, downsampling processing may be performed on the chroma prediction reference block. When the cross-component prediction model is applied, all samples in the chroma prediction reference block need to be used as chroma samples.

Further, in embodiments of this application, when determining, according to the chroma sample in the chroma prediction reference block, a prediction reference luma sample set corresponding to the chroma sample, the chroma format parameter may be first determined. Then, the luma sample corresponding to the chroma sample may be determined in the luma prediction reference block according to the chroma format parameter and the chroma sample in the chroma prediction reference block. Finally, the prediction reference luma sample set may be determined according to the luma sample.

It should be noted that in embodiments of this application, the bitstream may be decoded to determine the chroma format parameter, and further, the chroma format of the current block may be determined according to the chroma format parameter.

It may be understood that, in embodiments of this application, the chroma format parameter may be used to indicate a chroma format corresponding to the current block. The chroma format may be a picture color format, and may include 4:4:4, 4:2:2, and 4:2:0.

Further, in embodiments of this application, when the luma sample corresponding to the chroma sample is determined in the luma block of the current block according to the chroma format parameter and the chroma sample in the chroma block of the current block, the related luma coordinates may be first determined in the luma prediction reference block according to the chroma format parameter and the chroma sample coordinates in the chroma prediction reference block. Then, the sample corresponding to the related luma coordinates may be determined as the luma sample corresponding to the chroma sample.

It may be understood that, in embodiments of this application, the related luma coordinates may be coordinates that are in the luma prediction reference block and that correspond to coordinates of the chroma sample. The correspondence between the coordinates may be determined by using the chroma format parameter. Based on different chroma format parameters, the finally determined related luma coordinates are different.

For example, in some embodiments, chroma sample coordinates of the chroma sample may be (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of a first chroma format, the related luma coordinates (xY, yY) determined in the luma prediction reference block according to the chroma sample coordinates (xC, yC) may include the first coordinates L0 (xC, yC).

It may be understood that, in embodiments of this application, for the first chroma format 4:4:4, each Y component corresponds to a group of Cb and Cr components. In this case, the first coordinates L0 (xC, yC) corresponding to the same position as the coordinates of the chroma sample may be obtained in the luma prediction reference block as the related luma coordinates, that is, the sample having the first coordinates L0 (xC, yC) in the luma prediction reference block is the corresponding luma sample.

That is, in embodiments of this application, in a case in which the current block is of a first chroma format, the determined prediction reference luma sample set includes a luma sample having first coordinates L0 (xC, yC) corresponding to chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of the second chroma format, the related luma coordinates (xY, yY) determined in the luma prediction reference block according to the chroma sample coordinates (xC, yC) includes the second coordinates L1 (xC<<1, yC), the third coordinates L2 (xC<<1−1, yC), and the fourth coordinates L3 (xC<<1+1, yC).

It may be understood that, in embodiments of this application, for the second chroma format 4:2:2, every two Y components share one group of Cb and Cr components. If the coordinates of the chroma sample are (xC, yC), the related luma coordinates corresponding to the coordinates of the chroma sample in the luma prediction reference block are the second coordinates L1 (xC<<1, yC), the third coordinates L2 (xC<<1−1, yC), and the fourth coordinates L3 (xC<<1+1, yC). That is, the samples having the second coordinates L1 (xC<<1, yC), the third coordinates L2 (xC<<1−1, yC), and the fourth coordinates L3 (xC<<1+1, yC) in the luma prediction reference block are corresponding luma samples.

That is, in embodiments of this application, in a case in which the current block is of a second chroma format, the determined prediction reference luma sample set includes luma samples having second coordinates L1 (xC<<1, yC), third coordinates L2 (xC<<1−1, yC), and fourth coordinates L3 (xC<<1+1, yC) that correspond to the chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of a third chroma format, the related luma coordinates (xY, yY) determined in the luma prediction reference block according to the chroma sample coordinates (xC, yC) includes: fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1).

It may be understood that, in embodiments of this application, for the third chroma format 4:2:0, every four Y components share one group of Cb and Cr components. If the coordinates of the chroma sample are (xC, yC), the related luma coordinates corresponding to the coordinates of the chroma sample in the luma prediction reference block are the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), the tenth coordinates L9 (xC<<1+1, yC<<1+1). That is, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) in the luma prediction reference block are corresponding luma samples.

That is, in embodiments of this application, in a case in which the current block is of a third chroma format, the determined prediction reference luma sample set includes luma samples having fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1) that correspond to chroma sample coordinates (xC, yC).

It should be noted that, in embodiments of this application, << is a left shift operator, where m<<n indicates that an operation of a left shift by n bits is performed on a binary number of m, a result of m<<n is m×2ⁿ, and m and n are integers greater than 0.

That is, in embodiments of this application, the luma sample includes a co-located sample of the chroma sample in the luma prediction reference block, and/or a sample adjacent to the co-located sample.

For example, in some embodiments, the luma sample may include a co-located sample of the chroma sample in the luma prediction reference block, such as a sample of coordinates (xY, yY), and/or a sample that is adjacent to the co-located sample, such as samples having coordinates (xY−1, yY), (xY+1, yY), (xY, yY+1), (xY−1, yY+1), and (xY+1, yY+1).

In step 107, a predicted value of the chroma component of the current block is determined according to the model parameter of the cross-component prediction model, the prediction reference luma sample set, the residual value of the luma component of the current block, and the reconstructed value of the luma component of the current block.

In embodiments of this application, after the prediction reference luma sample set corresponding to the chroma sample is determined according to the chroma sample in the chroma prediction reference block, and the model parameter of the cross-component prediction model is determined according to the model reference luma sample set, the residual value of the luma component of the current block, and the prediction reference block of the current block, the predicted value of the chroma component of the current block may be further determined according to the model parameter of the cross-component prediction model, the prediction reference luma sample set, the residual value of the luma component of the current block, and the reconstructed value of the luma component of the current block.

It should be noted that in embodiments of this application, after determining the prediction reference luma sample set that uses the cross-component prediction model, the luma sample and the chroma sample may be further screened with reference to the residual value of the luma component of the current block, and the corrected chroma predicted value of the cross-component prediction model is used for the screened sample whose residual value meets a requirement.

Further, in embodiments of this application, when determining the predicted value of the chroma component of the current block according to the model parameter of the cross-component prediction model, the prediction reference luma sample set, the residual value of the luma component of the current block, and the reconstructed value of the luma component of the current block, the second availability parameter of the luma sample in the prediction reference luma sample set may be first determined according to the residual value of the luma component of the current block. Then, the predicted value of the chroma component of the current block may be determined according to the second availability parameter, the model parameter of the cross-component prediction model, and the reconstructed value of the luma component of the current block.

It should be noted that, in embodiments of this application, the second availability parameter may be used to indicate whether to use the luma reconstructed value of the luma sample. For a luma sample, if a corresponding second availability parameter indicates “available”, it may be understood that the luma reconstructed value of the luma sample is used. If the corresponding second availability parameter indicates “unavailable”, it may be understood that the luma reconstructed value of the luma sample is not used.

Further, in embodiments of this application, when the second availability parameter of the luma sample in the prediction reference luma sample set is determined according to the residual value of the luma component of the current block, in a case in which the residual value of the luma component of the current block corresponding to the luma sample meets the second condition, it may be determined that the second availability parameter of the luma sample indicates that the luma reconstructed value of the luma sample is not used. In a case in which the residual value of the luma component of the current block corresponding to the luma sample does not meet the second condition, it may be determined that the second availability parameter of the luma sample indicates that the luma reconstructed value of the luma sample is used.

It should be noted that, in embodiments of this application, for a luma sample, the residual value of the luma component of the current block at luma sampling coordinates of the luma sample is determined first, that is, a value corresponding to the luma sample. Then, it is determined whether the residual value of the luma sampling coordinate meets a second condition. If the residual value meets the second condition, it is determined that the second availability parameter of the luma sample is “unavailable”, that is, it indicates that the luma reconstructed value of the luma sample is not used. Otherwise, it is determined that the second availability parameter of the luma sample is “available”, that is, it indicates that the luma reconstructed value of the luma sample is used.

It may be understood that, in embodiments of this application, the second condition may be used to distinguish and screen the residual value with reference to a preset second residual threshold. The second condition may include: a residual value of the luma component of the current block corresponding to a luma sample is less than or equal to a second residual threshold.

It should be noted that, in embodiments of this application, the first residual threshold may be the same as or different from the second residual threshold, and this application sets no specific limitation thereto. The value of the second residual threshold may be any preset value. For example, the second residual threshold may be 0, or may be 4.

That is, when the second availability parameter is determined for the luma reference point, the residual value of the luma component corresponding to the luma sample may be compared with the second residual threshold. If a comparison result is that the residual value of the luma component corresponding to the luma sample is less than or equal to the second residual threshold, it may be determined that the luma prediction accuracy of the luma sample is relatively high. It may be considered that the luma reconstructed value of the luma sample is not applicable to correction of the chroma predicted value of the sample with low prediction accuracy. Therefore, the luma reconstructed value of the luma sample may be not used, that is, it may be determined that the second availability parameter of the luma sample indicates that the luma reconstructed value of the luma sample is not used.

Correspondingly, in embodiments of this application, if the comparison result is that the residual value of the luma component corresponding to the luma sample is greater than the second residual threshold, it may be determined that the luma prediction accuracy of the luma sample is relatively low. It may be considered that the luma reconstructed value of the luma sample is applicable to correction of the chroma predicted value of a sample with low prediction accuracy. Therefore, the luma reconstructed value of the luma sample may be used, that is, it may be determined that the second availability parameter of the luma sample indicates that the luma reconstructed value of the luma sample is used.

It should be noted that, in embodiments of this application, the second availability parameter may be determined by comparing the residual value of the luma component corresponding to the luma sample with the second residual threshold, or the second availability parameter may be determined in any other manner. For example, the residual value of the luma component corresponding to the luma sample is shifted right by 2 bits, and then compared with the second residual threshold.

For example, in some embodiments, assuming that the second residual threshold is 0. The luma sample is screened according to the residual value of the luma component of the current block. If the residual value of the luma component of the current block corresponding to the luma sample is 0, that is, is less than or equal to the second residual threshold, the luma reconstructed value of the luma sample is not used. If the residual value of the luma component of the current block corresponding to the luma sample is not 0, that is, is greater than the second residual threshold, the luma reconstructed value of the luma sample is used.

Further, in embodiments of this application, when the predicted value of the chroma component of the current block is determined according to the second availability parameter, the model parameter of the cross-component prediction model, and the reconstructed value of the luma component of the current block, in a case in which the second availability parameter indicates that the luma reconstructed value of the luma sample is used, it is determined that the reconstructed value of the luma component of the current block corresponds to the luma reconstructed value of the luma sample. Then, the predicted value of the chroma component of the current block may be determined according to the luma reconstructed value, the model parameter, the nonlinear term, and/or the offset term.

It should be noted that, in embodiments of this application, the cross-component prediction model may include InterCCCM. The cross-component prediction model may be an 8-tap filter including six spatial luma samples, a non-linear term, and an offset term, such as the foregoing formula (3).

Exemplarily, in some embodiments, for a chroma sample, if a residual value of a luma sample corresponding to the chroma sample (that is, a luma residual of a luma component of a current block corresponding to the luma sample) is greater than a second residual threshold, that is, a second availability parameter corresponding to the luma sample indicates that a luma reconstructed value of the luma sample may be used, a luma reconstructed value of the luma sample may be determined according to the reconstructed value of the luma component of the current block. Then, a chroma predicted value is corrected based on the foregoing formula (4) and (5), a nonlinear term and/or an offset term, and a model parameter c₀~c₇ obtained by derivation, and the corrected chroma predicted value of a corresponding chroma sample is determined, thereby determining a predicted value of the chroma component of the current block.

### Bitmap

Further, in embodiments of this application, when determining, according to the luma prediction reference block, the luma sampling value corresponding to the luma sample, a value of the luma prediction reference block corresponding to the luma sample may be selected as the luma reconstructed value. Alternatively, if the value of the luma prediction reference block corresponding to the luma sample is not 0, the luma reconstructed value may be determined based on the luma offset value and the value corresponding to the luma sample.

It may be understood that, in embodiments of this application, in a process of using a model parameter, to reduce a dynamic range of data and to bit depth required by the derivation, a luma offset value may be introduced.

For example, in some embodiments, the luma offset value may be subtracted from the luma reconstructed value participating in model application, so as to obtain a corresponding luma reconstructed value, and further, the luma reconstructed value is used to correct the chroma predicted value.

It should be noted that in embodiments of this application, the luma offset value (offsetY) may be simply represented by using an average value of four vertex pixel values of the luma prediction block.

That is, in embodiments of this application, in a model application process, a finally used luma reconstructed value L0′~L5′ is a difference between a reconstructed value L0″~L5″ (the value is not 0) corresponding to the luma sample and a luma offset value offsetY.

It should be noted that, in embodiments of this application, for different chroma formats indicated by different chroma format parameters, the chroma sample may correspond to different quantities of luma samples. For example, for the first chroma format 4:4:4, one chroma sample corresponds to one luma sample. For the second chroma format 4:2:2, one chroma sample corresponds to three luma samples. For the second chroma format 4:2:0, one chroma sample corresponds to six luma samples. That is, the chroma sample corresponds to at least one luma sample. In a process of determining the first availability parameter of the luma sample, a corresponding first availability parameter may be determined based on some or all of the at least one luma sample. This is not specifically limited in this application.

That is, in embodiments of this application, for the at least one luma sample, in a case in which a residual value corresponding to any one of the luma samples is less than or equal to a second residual threshold, it is determined that the second availability parameters corresponding to all the luma samples each indicate “unavailable”.

Correspondingly, in embodiments of this application, for at least one luma sample, in a case in which residual values corresponding to all luma samples each are less than or equal to the second residual threshold, it is determined that the second availability parameters corresponding to all luma samples each indicate “unavailable”.

Exemplarily, in some embodiments, assuming that the second residual threshold is 0. For the first chroma format 4:4:4, each Y component corresponds to a group of Cb and Cr components. In this case, a sample having the first coordinates L0 (xC, yC) co-located with the chroma sample coordinates in the luma prediction reference block may be determined as the corresponding luma sample. If the residual value of the luma component of the current block corresponding to the luma sample L0 (xC, yC) is 0, it may be considered that the second availability parameter corresponding to the luma sample represents “unavailable”. Therefore, none of the luma reconstructed values corresponding to the first coordinate L0 (xC, yC) participates in the model application.

Exemplarily, in some embodiments, assuming that the second residual threshold is 0. For the second chroma format 4:2:2, every two Y components share a group of Cb and Cr components. In this case, samples having the second coordinates L1 (xC<<1, yC), the third coordinates L2 (xC<<1−1, yC), and the fourth coordinates L3 (xC<<1+1, yC) that are in the luma prediction reference block and are co-located with the chroma sample coordinates may be determined as the corresponding luma samples. If the residual value of the luma component of the current block corresponding to the luma sample L1 (xC<<1, yC) is 0, it may be considered that the second availability parameter corresponding to all the luma samples indicates “unavailable”. Therefore, the corresponding luma reconstructed values at the second coordinates L1 (xC<<1, yC), the third coordinates L2 (xC<<1−1, yC), and the fourth coordinates L3 (xC<<1+1, yC) do not participate in the model application.

Exemplarily, in some embodiments, assuming that the second residual threshold is 0. For the third chroma format 4:2:0, every four Y components share a group of Cb and Cr components. In this case, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) that are in the luma prediction reference block and are co-located with the chroma sample coordinates are determined as the corresponding luma samples. If the residual value of the luma component of the current block corresponding to the luma sample L4 (xC<<1, yC<<1) is 0, it may be considered that the second availability parameter corresponding to all the luma samples represents “unavailable”. Therefore, none of the corresponding luma reconstructed values at the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) participates in the model application.

It should be noted that, in embodiments of this application, if the second availability parameters corresponding to all luma samples in the prediction reference luma sample set each represent “unavailable”, the luma sample and the chroma sample are no longer screened and distinguished, but the model application continues to be performed by using the luma reconstructed value of the luma sample.

Further, in embodiments of this application, when determining the predicted value of the chroma component of the current block according to the luma reconstructed value, the model parameter, the non-linear term, and/or the offset term, a chroma prediction correction block of the current block may be first determined according to the luma reconstructed value, the model parameter, the non-linear term, and/or the offset term. Then, the predicted value of the chroma component of the current block may be determined according to a preset weight, the chroma prediction reference block, and the chroma prediction correction block.

It should be noted that, in embodiments of this application, after the correction to the chroma component of the current block is completed by using the cross-component prediction model, the chroma prediction correction block of the current block corresponding to the chroma prediction reference block of the current block may be determined, and then the chroma prediction reference block and the chroma prediction correction block may be weighted by using a preset weight to obtain a predicted value of the chroma component of the current block. That is, the predicted value of the chroma component of the current block may be obtained by performing a weighted operation on an initial predicted value (chroma prediction reference block) of the chroma component of the current block and the corrected predicted value (chroma prediction correction block) of the chroma component of the current block.

For example, in some embodiments, based on the foregoing formula (3), the chroma prediction correction block of the current block is determined according to the luma reconstructed value, the model parameter, the nonlinear term, and/or the offset term. That is, after the corrected predicted value of the chroma component of the current block (predCbVal for the Cb component, predCrVal for the Cr component) is obtained, a weighting operation may be further performed on the corrected predicted value of the chroma component and the chroma prediction reference block, that is, the initial prediction value of the chroma component of the current block (predSamplesCb for the Cb component, predSamplesCr for the Cr component). For example, the foregoing formula (6) and (7) are used to perform a weighting operation, so that a final predicted value of the chroma component (predSamplesCb′ for the Cb component, predsamplesCr′ for the Cr component) may be obtained.

It should be noted that in embodiments of this application, the preset weight may be a preset value, and the preset weight may be greater than or equal to 0 and less than or equal to 1. For example, the preset weight w is 0.75.

Further, in embodiments of this application, when the predicted value of the chroma component of the current block is determined according to the luma reconstruction value, the model parameter, the nonlinear term, and/or the offset term, the chroma prediction correction block of the current block may be first determined according to the luma reconstructed value, the model parameter, the nonlinear term, and/or the offset term. In addition, a first weight may be determined according to the residual value of the luma component of the current block. Then, the predicted value of the chroma component of the current block may be determined according to the first weight, the chroma prediction reference block, and the chroma prediction correction block.

It should be noted that, in embodiments of this application, the weight used to perform the weighting operation on the initial prediction value (chroma prediction reference block) of the chroma component of the current block and the corrected prediction value (chroma prediction correction block) of the chroma component of the current block may be the first weight. The first weight may be determined by using the residual value of the luma component of the current block.

It may be understood that, in embodiments of this application, when the first weight is determined according to the residual value of the luma component of the current block, for the luma sample, a smaller residual value corresponding to the luma sample may indicate a more accurate predicted position corresponding to the luma sample. In this case, for the determined first weight, a larger weight value may be assigned to an initial predicted value of the corresponding chroma sample.

That is, in embodiments of this application, when the weighting operation is performed on the chroma prediction reference block and the chroma prediction correction block, the weight may be determined by using the residual value of the luma sample corresponding to the chroma sample. That is, the first weight is determined according to the residual value of the luma component of the current block. If the residual value of the corresponding luma sample is smaller, it may be considered that the prediction value of the chroma sample at the corresponding position is more accurate, and therefore, the weight of the corresponding chroma prediction reference block is larger.

Exemplarily, in some embodiments, it is assumed that an absolute value of a prediction residual of a luma sample at L0″ is AbsResLuma. In this case, if AbsResLuma<5, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.75:0.25, so that a final predicted value of the chroma component (predSamplesCb′ for a Cb component, predSamplesCr′ for a Cr component) may be obtained, as shown by the following formula:

predSamplesCb′=(3×predSamplesCb+predCbVal+2)»2 (11)

predSamplesCr′=(3×predSamplesCr+predCrVal+2)»2 (12)

Exemplarily, in some embodiments, it is assumed that an absolute value of a prediction residual of a luma sample at L0″ is AbsResLuma. In this case, if 5≤AbsResLuma<20, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.5:0.5, so that a final predicted value of the chroma component (predSamplesCb′ for a Cb component, predSamplesCr′for a Cr component) may be obtained, as shown by the following formula:

predSamplesCb′=(predSamplesCb+predCbVal+1)»1 (13)

predSamplesCr′=(predSamplesCr+predCrVal+1)»1 (14)

For example, in some embodiments, it is assumed that an absolute value of a prediction residual of a luma sample at L0″ is AbsResLuma. In this case, if 20≤AbsResLuma, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.25:0.75, so that a final predicted value of the chroma component (predSamplesCb′ for a Cb component, predSamplesCr′ for a Cr component) may be obtained, as shown by the following formula:

predSamplesCb′=(predSamplesCb+3×predCbVal+2)»2 (15)

predSamplesCr′=(predSamplesCr+3×predCrVal+2)»2 (16)

Further, in embodiments of this application, when the predicted value of the chroma component of the current block is determined according to the luma reconstructed value, the model parameter, the nonlinear term, and/or the offset term, the chroma prediction correction block of the current block may be first determined according to the luma reconstructed value, the model parameter, the nonlinear term, and/or the offset term. In addition, a nonlinear weighting coefficient may be determined. Then, the predicted value of the chroma component of the current block may be determined according to the first weight, the chroma prediction reference block, and the chroma prediction correction block.

It should be noted that in embodiments of this application, the initial predicted value (chroma prediction reference block) of the chroma component of the current block and the corrected predicted value (chroma prediction correction block) of the chroma component of the current block may be weighted in a non-linear weighting manner. That is, when the weighting operation is performed on the chroma prediction reference block and the chroma prediction correction block, the determined nonlinear weighting coefficient may be used to perform nonlinear weighting on the chroma prediction reference block and the chroma prediction correction block.

For example, in some embodiments, when determining a final predicted value of the chroma component (predSamplesCb′ for a Cb component, predSamplesCr′ for a Cr component), nonlinear weighting is performed on a predicted value of a chroma sample in the chroma prediction reference block (predSamplesCb for a Cb component, predSamplesCr for a Cr component) and a predicted value of a corresponding position in the chroma prediction correction block (predCbVal for a Cb component, predCrVal for a Cr component), as shown in the following formula:

predSamplesCb′=a₀predSamplesCb+a₁predCbVal+a₂nonlinear((predSamplesCb+predCbVal+1)»1)+a₃B (17)

predSamplesCr′=a₄predSamplesCr+a₅predCrVal+a₆nonlinear((predSamplesCr+predCrVal+1)»1)+a₇B (18)

In which, the nonlinear term nonlinear and the offset term B are determined by using the foregoing formula (4) and formula (5). a₀~a₇ represents a nonlinear weighting coefficient, and may be derived from the reference template of the current chroma prediction block (an upper row and a left column of the current chroma prediction block).

For example, in some embodiments, it is assumed that the first chroma predicted value (predRefCb for the Cb component, predRefCr for the Cr component), the second chroma predicted value (predRefCbVal for the Cb component, predRefCrVal for the Cr component), and the chroma reconstructed value (recRefCb for the Cb component, recRefCr for the Cr component) of the reference template. The equation may be established according to the following formula, and the model coefficient a₀~a₇ may be solved by using, for example, a division-free Gaussian elimination method in ECM-10.0:

recRefCb=a₀predRefCb+a₁predRefCbVal+a₂nonlinear((predRefCb+predRefCbVal+1)»1)+a₃B (19)

recRefCr=a₄predRefCr+a₅predRefCrVal+a₆nonlinear((predRefCr+predRefCrVal+1)»1)+a₇B (20)

In which, the nonlinear term nonlinear and the offset term B are determined by using the foregoing formula (4) and formula (5).

It should be noted that in embodiments of this application, for luma samples for which the second availability parameters each indicate “unavailable”, the luma samples and the chroma samples may no longer be screened and distinguished.

In conclusion, the decoding method proposed in step 101 to step 107 mainly includes a method for screening a luma sample (a luma sample) that participates in model parameter calculation and application. The luma reconstructed value may be filtered, so that the chroma predicted value may be corrected, and the prediction residual is further reduced. In one aspect, when calculating the model parameter, it may be determined whether the luma sample residual of the luma sample is less than or equal to the first residual threshold. If the luma sample residual of the luma sample is less than or equal to the first residual threshold, the chroma prediction sample at the corresponding position and the luma prediction sample closest to the chroma prediction sample do not participate in calculation of the model parameter. In another aspect, when the model is applied, it may be determined whether the luma sample residual of the luma sample is less than or equal to the second residual threshold. If the luma sample residual of the luma sample is less than or equal to the second residual threshold, the chroma prediction sample at the corresponding position is not corrected.

It can be learned that according to the decoding method provided in embodiments of this application, in a process of calculating and applying the model parameters, chroma predicted values corresponding to luma samples with relatively high prediction accuracy are not corrected, for example, chroma prediction samples corresponding to luma samples residual 0 at L0″ are not corrected, so that prediction accuracy is improved to some extent, and encoding complexity is ensured.

An embodiment of this application provides a decoding method. A prediction reference block of a current block is determined according to a prediction parameter of the current block. The prediction reference block includes a luma prediction reference block and a chroma prediction reference block, a size of the luma prediction reference block is the same as a size of a luma block of the current block, and a size of the chroma prediction reference block is the same as a size of a chroma block of the current block. A reconstructed value of the luma component of the current block is determined according to the residual value of the luma component of the current block and the luma prediction reference block. According to the chroma sample in the chroma prediction reference block, a model reference luma sample set corresponding to the chroma sample is determined. Model parameters of the cross-component prediction model are determined according to the model reference luma sample set, the residual value of the luma component of the current block, and the prediction reference block of the current block. According to the chroma sample in the chroma prediction reference block, a prediction reference luma sample set corresponding to the chroma sample is determined. The predicted value of the chroma component of the current block is determined according to the model parameter of the cross-component prediction model, the prediction reference luma sample set, the residual value of the luma component of the current block, and the reconstructed value of the luma component of the current block. That is, in embodiments of this application, in a process of determining the model parameter of the cross-component prediction model, the luma sample that participates in model parameter derivation may be screened according to the residual value of the luma component of the current block. In addition, in a process of applying the cross-component prediction model, the luma sample may also be screened according to the residual value of the luma component of the current block. Therefore, in a process of model derivation and application, whether to use the luma prediction sample may be determined according to prediction accuracy of the luma prediction sample, so that a model parameter that can more accurately reflect a relationship between the luma prediction sample and the chroma prediction sample may be obtained. At the same time, a better correction effect may be obtained, thereby improving accuracy of the chroma prediction, and further improving the coding performance.

Based on the foregoing embodiments, another embodiment of this application provides a prediction method. The prediction method may include an encoding method and a decoding method, and may be applied to an encoder or a decoder.

For example, in some embodiments, according to the prediction method provided in embodiments of this application, determining of a model parameter of a cross-component prediction model and an application of the cross-component prediction model may be improved. The cross-component prediction model may include an InterCCCM. For example, the cross-component prediction model may be an InterCCCM-based InterCCCM-LumaResi.

Exemplarily, in some embodiments, input of InterCCCM-LumaResi includes: a luma predicted value predSamplesY[x][y] of the current block, that is, a luma prediction reference block; a luma reconstructed value recSamplesY[x][y], that is, a reconstructed value of the luma component of the current block; a luma prediction residual resSamplesY[x][y], that is, a residual value of the luma component of the current block; and a first chroma predicted value (predSamplesCb[x1][y1] for the Cb component and predSamplesCr[x1][y1] for the Cr component), that is, a chroma prediction reference block, where x=0 . . . nTbW-1, y=0 . . . nTbH-1, x1=0 . . . nTbWC-1, and y1=0 . . . nTbHC-1.

It may be understood that in embodiments of this application, the luma predicted value, the luma reconstructed value, the luma residual value, and the chroma predicted value may be selected as four different inputs. Alternatively, only the luma predicted value, the luma reconstructed value, and the chroma predicted value may be input, and then a difference between the luma reconstructed value and the luma predicted value is calculated to obtain the luma residual value.

It may be understood that in embodiments of this application, the luma predicted value, the luma reconstructed value, the luma residual value, and the chroma predicted value may be selected as four different inputs. Alternatively, only the luma predicted value, the luma residual value and the chroma predicted value may be input, and a sum of the luma predicted value and luma residual value is calculated to obtain the luma reconstructed value.

It may be understood that in embodiments of this application, the luma predicted value, the luma reconstructed value, the luma residual value, and the chroma predicted value may be selected as four different inputs. Alternatively, only the luma reconstructed value, the luma residual value, and chroma prediction value may be input, and a difference between the luma reconstructed value and the luma residual value is calculated to obtain the luma predicted value.

It should be noted that in embodiments of this application, the input of the InterCCCM-LumaResi may be an inter prediction value or a predicted value of an intra prediction mode (for example, an IBC mode). For example, the luma predicted value may be an inter mode predicted value, and the chroma predicted value may be an intra mode predicted value. Alternatively, the luma predicted value may be an intra mode predicted value, and the chroma predicted value may be an inter mode predicted value. Alternatively, the luma predicted value and the chroma predicted value may be predicted values generated by performing weighting on intra and inter mode predicted values.

Exemplarily, in some embodiments, an output of InterCCCM-LumaResi is a third chroma predicted value of the current block (predSamplesCb ‘[x][y] for the Cb component and predSamplesCr’ [x][y] for the Cr component), that is, a predicted value of the chroma component of the current block, where x=0 . . . nTbWC-1, y=0 . . . nTbHC-1.

For example, in some embodiments, a specific process of the InterCCCM-LumaResi includes: solving a model parameter and generating a third chroma predicted value of the current block. When the model parameter is calculated, after the chroma prediction sample position (chroma sampling coordinates of the chroma sample) is obtained, it is determined whether a residual of one (for example, at L0) or more luma samples at a corresponding position is 0 (for example, a first residual threshold). If the residual is 0, a chroma prediction sample at the corresponding position and a luma prediction sample closest to the chroma prediction sample do not participate in the model parameter calculation. In applying the model, after obtaining the chroma prediction sample position, it is determined whether a residual of one (e.g., at L0″) or more luma samples at the corresponding position is 0 (e.g., a second residual threshold). If the residual is 0, the chroma prediction sample at the corresponding position is not corrected.

For example, in some embodiments, the cross-component prediction model may be an 8-tap filter including six spatial luma samples, a non-linear term, and an offset term, such as the foregoing formula (3). The nonlinear term nonlinear and the offset term B are determined by using the foregoing formula (4) and formula (5), and the model parameter c₀~c₇ may be obtained by solving the equation, for example, by using a division-free Gaussian elimination method.

For example, in some embodiments, to reduce a quantity of luma and chroma prediction samples that participate in model parameter calculation, a downsampling step dsX and a downsampling step dsY in a x direction and a y direction are first determined according to a width and a height of the chroma prediction block (the chroma prediction reference block), so as to perform downsampling on the chroma prediction block. In the foregoing formula, predChromaVal represents a downsampled chroma predicted value (the chroma sample).

It may be understood that, in embodiments of this application, a model parameter calculation may be directly performed by using all samples without performing downsampling processing.

For example, in some embodiments, the luma prediction sample (luma sample) and the chroma prediction sample (chroma sample) may include different position relationships according to different picture color formats (chroma format).

For example, in some embodiments, it is assumed that the first residual threshold is 0. As shown in FIG. 3, for the first chroma format 4:4:4, each Y component corresponds to a group of Cb and Cr components. In this case, the luma prediction value L0 corresponding to the position of the first chroma prediction value C is obtained. It is determined whether the luma sample residual at L0 is 0. If the luma sample residual is 0, the chroma prediction sample at this position and the luma prediction sample closest to the chroma prediction sample do not participate in the model parameter calculation. Otherwise, L0 is obtained, and a value of L1~L5 is 0.

Exemplarily, in some embodiments, it is assumed that the first residual threshold is 0. As shown in FIG. 4, for the second chroma format 4:2:2, every two Y components share a group of Cb and Cr components. In this case, if the chroma sample is located at C0, the luma samples closest to the chroma sample are located at L0 and L2. It is determined whether the luma sample residual at L0 is 0. If the luma sample residual is 0, the chroma prediction sample at this position and the luma prediction sample closest to the chroma prediction sample do not participate in the model parameter calculation. Otherwise, L0~L2 are obtained. When applied to a calculation formula, a value of L1 is regarded to be equal to L0, and a value of L3~L5 is 0. If the chroma sample is located at Cm (m≠0), it is determined whether the luma sample residual at L0 is 0. If the luma sample residual is 0, the chroma prediction sample at this position and the luma prediction sample closest to the chroma prediction sample do not participate in the model parameter calculation. Otherwise, luma predicted values L1 and L2 on both sides of L0 and L0 are obtained, and a value of L3~L5 is 0. It may be understood that, between left and right adjacent chroma sampling positions, the L2 position corresponding to a left sample corresponds to the L1 position corresponding to the right sample. L0, L1, and L2 in FIG. 4 may correspond to second coordinates L1 (xC<<1, yC), third coordinates L2 (xC<<1−1, yC), and fourth coordinates L3 (xC<<1+1, yC) that are determined in a second chroma format 4:2:2.

Exemplarily, in some embodiments, it is assumed that the first residual threshold is 0. As shown in FIG. 5, for the third chroma format 4:2:0, every four Y components share a group of Cb and Cr components. In this case, if the chroma sample is located at C0, the luma sample closest to the chroma sample is located at L0, L2, L3, and L5. It is determined whether the luma sample residual at L0 is 0. If the luma sample residual is 0, the chroma prediction sample at this position and the luma prediction sample closest to the chroma prediction sample do not participate in the model parameter calculation. Otherwise, L0~L5 are obtained. When applied to the calculation formula, a value of L1 is regarded to be equal to L0, and a value of L4 is regarded to be equal to L3. If the chroma sample is located at Cm (m≠0), it is determined whether the luma sample residual at L0 is 0. If the luma sample residual is 0, the chroma prediction sample at this position and the luma prediction sample closest to the chroma prediction sample do not participate in the model parameter calculation. Otherwise, L0~L5 are obtained. It may be understood that, between left and right adjacent chroma sampling positions, L2 position corresponding to the left sample corresponds to L1 position corresponding to the right sample, and L5 position corresponding to the left sample corresponds to L4 position corresponding to the right sample. L0-L5 in FIG. 5 may correspond to fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1) that are determined in the third chroma format 4:2:0.

It may be understood that, in embodiments of this application, when determining the sample not participating in the model parameter calculation and/or the model application, the sample may be determined not only according to the luma residual value corresponding to the L0 position, but also according to multiple residual values in L0~L5. For example, the sample is determined based on L0 and L1, L0 and L3, or L0~L2. Alternatively, the sample may be determined according to the chroma residual value of the position corresponding to the chroma sample being 0.

Exemplarily, in some embodiments, in a model parameter calculation process, luma and chroma offset values are introduced to reduce a dynamic range of data and bit depth required by the derivation. The luma predicted value and the chroma predicted value that participate in the model parameter calculation subtract the luma offset value and the chroma offset value. In the InterCCCM technology, the luma offset value (offsetY) and the chroma offset value (offsetCb for the Cb component and offsetCr for the Cr component) may be simply represented by using an average of four vertex pixel values of the luma prediction block and the chroma prediction block.

Exemplarily, in some embodiments, the finally used luma sampling value L0′~L5′ is a difference between L0~L5 (the value is not 0) and an offsetY. The model parameters are obtained by establishing equations about predChromaVal, L0′~L5′, the non-linear term and the offset term and using the division-free Gaussian elimination method in, for example, ECM10.0. OffsetCb and offsetCr also participate in the model parameter calculation.

It should be noted that, in embodiments of this application, the average values of the four vertex pixel values of the luma prediction block and the chroma prediction block may be first calculated, and are used as offsetY, offsetCb, and offsetCr to construct a prediction block from which the average value is subtracted. Downsampling is performed on a chroma prediction block from which the average value is subtracted, to determine a position of the first chroma prediction value that participates in model parameter calculation.

It should be noted that, in embodiments of this application, L0′~L5′ participating in the model parameter calculation is L0~L5 before the average value is subtracted, rather than a difference between L0~L5 and the offsetY, and offsetCb and offsetCr are not used to calculate the model parameter. L0′~L5′ participating in the application model is L0″~L5″ before the average value is subtracted, rather than the difference between L0″~L5″ and the offsetY.

Exemplarily, in some embodiments, if the luma sample residual at L0 corresponding to all downsampled sample positions of the chroma prediction block is 0, for the 4:4:4 colour format, each Y component corresponds to a group of Cb and Cr components. In this case, the luma prediction value L0 corresponding to the position of the first chroma prediction value C is obtained, and values of L1~L5 are 0. For the 4:2:2 colour format, every two Y components share a group of Cb and Cr components. If the chroma sample position is C0, the luma samples closest to the chroma sample position are at L0 and L2, and L0~L2 are obtained (corresponding to the second coordinates L1 (xC<<1, yC), the third coordinates L2 (xC<<1−1, yC), and the fourth coordinates L3 (xC<<1+1, yC) determined under the second chroma format 4:2:2). When applied to the calculation formula, a value of L1 is regarded to be equal to L0, and the values of L3~L5 are 0. If the chroma sample position is Cm (m≠0), L0 and the luma prediction values L1 and L2 on the left and right sides of L0 are obtained, and the values of L3~L5 are 0. It may be understood that between left and right adjacent chroma sampling positions, the L2 position corresponding to the left sample corresponds to the L1 position corresponding to the right sample. For the 4:2:0 colour format, every four Y components share a group of Cb and Cr components. If the Chroma sample position is C0, luma samples closest to the chroma sample position are at L0, L2, L3, and L5, and L0~L5 are obtained (corresponding to the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinate L9 (xC<<1+1, yC<<1+1) determined under the third chroma format 4:2:0). When applied to the calculation formula, the value of L1 is regarded to be equal to L0, and the value of L4 is regarded to be equal to L3. If the chroma sample position is Cm (m≠0), L0~L5 are obtained. It may be understood that between left and right adjacent chroma sampling positions, the L2 position corresponding to the left sample corresponds to the L1 position corresponding to the right sample, and the L5 position of the left sample corresponds to the L4 position corresponding to the right sample.

For example, in some embodiments, based on the foregoing formula (3), a second chroma prediction value predChromaVal of the current block, that is, a chroma prediction correction block, may be generated by using the determined model parameter. In which, model parameter c₀~c₇ is a model parameter obtained in the previous step. L0′~L5′ is a difference between the luma reconstructed value L0″~L5″ (the value is not 0) and the luma offset value (offsetY).

It should be noted that, in embodiments of this application, if the average value of the six spatial luma sample values is 0, a chroma prediction sample at a corresponding location may not be corrected.

Exemplarily, in some embodiments, the chroma prediction block is not downsampled when the model is applied. The luma reconstruction samples corresponding to all the first chroma predicted values in the chroma prediction block participate in the model application.

For example, in some embodiments, it is assumed that the second residual threshold is 0. As shown in FIG. 6, for the first chroma format 4:4:4, each Y component corresponds to a group of Cb and Cr components. In this case, the luma reconstructed value L0″ corresponding to the position of the first chroma predicted value C is obtained. It is determined whether the luma sample residual at L0″ is 0. If the luma sample residual is 0, the chroma prediction sample at this position and the luma reconstruction sample closest to the chroma prediction sample do not participate in the model application. Otherwise, L0″ is obtained, and a value of L1″~L5″ is 0.

For example, in some embodiments, it is assumed that the second residual threshold is 0. As shown in FIG. 7, for the second chroma format 4:2:2, every two Y components share a group of Cb and Cr components. In this case, if the chroma sample position is C0, the luma samples closest to the chroma sample position are at L0″ and L2″. It is determined whether the luma sample residual at L0″ is 0. If the luma sample residual is 0, the chroma prediction sample at

this position and the luma reconstruction sample closest to the chroma prediction sample do not participate in the model application. Otherwise, when applied to the calculation formula, the value of L1″ is regarded to be equal to L0″, and the value of L3″~L5″ is 0. If the position of the chroma sample is Cm (m≠0), it is determined whether the luma sample residual at L0″ is 0. If the luma sample residual is 0, the chroma prediction sample at this position and the luma reconstruction sample closest to the chroma prediction sample do not participate in the model application. Otherwise, the luma reconstructed values L1″ and L2″ on the left and right sides of L0″ and L0″ are obtained, and the values of L3″~L5″ are 0. It may be understood that between left and right adjacent chroma sampling positions, the position L2″ corresponding to the left sample corresponds to the position L1″ corresponding to the right sample.

Exemplarily, in some embodiments, it is assumed that the second residual threshold is 0. As shown in FIG. 8, for the third chroma format 4:2:0, every four Y components share a group of Cb and Cr components. In this case, if the chroma sample position is C0, the luma samples closest to the chroma sample position are at L0″, L2″, L3″ and L5″. It is determined whether the luma sample residual at L0″ is 0. If the luma sample residual is 0, the chroma prediction sample at this position and the luma reconstruction sample closest to the chroma prediction sample do not participate in the model application. Otherwise, when applied to the calculation formula, the value of L1″ is regarded to be equal to L0″, and the value of L4″ is regarded to be equal to L3″. If the position of the chroma sample is Cm (m≠0), it is determined whether the luma sample residual at L0″ is 0. If the luma sample residual is 0, the chroma prediction sample at this position and the luma reconstruction sample closest to the chroma prediction sample do not participate in the model application. Otherwise, L0″~L5″ are obtained. It may be understood that between left and right adjacent chroma sampling positions, the position L2″ corresponding to the left sample corresponds to the position L1″ corresponding to the right sample, and the position L5″ corresponding to the left sample corresponds to the position L4″ corresponding to the right sample.

Exemplarily, in some embodiments, in an application model process, a luma offset value is introduced to reduce a dynamic range of data and bit depth required by the derivation. The luma offset is subtracted from the luma reconstructed value participating in the application model. The luma offset value (offsetY) is simply represented by an average value of pixel values of four vertices of the luma prediction block.

For example, in some embodiments, a weighted operation is performed on the obtained second chroma predicted value (predCbVal for a Cb component, predCrVal for a Cr component) and the first chroma predicted value (predSamplesCb for a Cb component, predSamplesCr for a Cr component) according to the foregoing formulas (6) and (7), to generate a third chroma predicted value (predSamplesCb′ for a Cb component, predSamplesCr^{'}for a Cr component).

For example, in some embodiments, when the second chroma predicted value and the first chroma predicted value are weighted, the weight is determined according to the luma sample residual value at L0″ corresponding to the first chroma predicted value. A smaller residual indicates a more accurate prediction of the chroma sample at the corresponding position, and a larger weight for the first chroma predicted value.

Exemplarily, in some embodiments, it is assumed that an absolute value of a prediction residual of a luma sample at L0″ is AbsResLuma. In this case, if AbsResLuma<5, a weighting operation is performed on the first chroma predicted value (predSamplesCb for a Cb component, predSamplesCr for a Cr component) and the second chroma predicted value (predCbVal for a Cb component, predCrVal for a Cr component) according to 0.75:0.25 to generate a third chroma predicted value (predSamplesCb′ for a Cb component, predsamplesCr′ for a Cr Component).

Exemplarily, in some embodiments, it is assumed that an absolute value of a prediction residual of a luma sample at L0″ is AbsResLuma. In this case, if 5≤AbsResLuma<20, a weighting operation is performed on the first chroma predicted value (predSamplesCb for a Cb component, predSamplesCr for a Cr component) and the second chroma predicted value (predCbVal for a Cb component, predCrVal for a Cr component) according to 0.5:0.5 to generate a third chroma predicted value (predSamplesCb′ for a Cb component, predSamplesCr′ for a Cr component).

Exemplarily, in some embodiments, it is assumed that an absolute value of a prediction residual of a luma sample at L0″ is AbsResLuma. In this case, if 20≤AbsResLuma, a weighting operation is performed on the first chroma predicted value (predSamplesCb for a Cb component, predSamplesCr for a Cr component) and the second chroma predicted value (predCbVal for a Cb component, predCrVal for a Cr component) according to 0.25:0.75 to generate a third chroma predicted value (predSamplesCb′ for a Cb component,

### Predsamplescr′ for a Cr Component).

For example, in some embodiments, a nonlinear weighting operation is performed on the first chroma predicted value (predSamplesCb for a Cb component, predSamplesCr for a Cr component) and the second chroma predicted value (predCbVal for a Cb component, predCrVal for a Cr component) to generate a third chroma predicted value (predSamplesCb′ for a Cb component, predSamplesCr′ for a Cr component).

Exemplarily, in some embodiments, if the luma sample residual at L0″ corresponding to all sample positions of the chroma prediction block is 0, for the 4:4:4 colour format, each Y component corresponds to a group of Cb and Cr components. In this case, a luma reconstructed value L0″ corresponding to the position of the first chroma prediction value C is obtained, and values of L1″~L5″ are 0. For the 4:2:2 colour format, every two Y components share a group of Cb and Cr components. If the chroma sample is located at C0, luma samples closest to the chroma sample location are at L0″ and L2″. L0″~L2″ are obtained (corresponding to the second coordinates L1 (xC<<1, yC), the third coordinates L2 (xC<<1−1, yC), and the fourth coordinates L3 (xC<<1+1, yC) that are determined in the second chroma format 4:2:2). When applied to a calculation formula, a value of L1″ is regarded to be equal to L0″, and a value of L3″~L5″ is 0. If the chroma sample is located at Cm (m≠0), and luma reconstruction values L1″ and L2″ on left and rights sides of L0″ and L0″ are obtained, and a value of L3″~L5″ is 0. It may be understood that between left and right adjacent chroma sampling positions, the position L2″ corresponding to the left sample corresponds to the position L1″ corresponding to the right sample. For the 4:2:0 colour format, every four Y components share a group of Cb and Cr components. If the chroma sample position is C0, the luma reconstructed samples closest to the chroma sample position are at L0″, L2″, L3″ and L5″, and L0″~L5″are obtained (corresponding to the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) determined in the third chroma format 4:2:0). When applied to the calculation formula, the value of L1″ is regarded to be equal to L0″, and the value of L4″ is regarded to be equal to L3″. If the chroma sample position is Cm (m≠0), L0″~L5″ are obtained. It may be understood that between left and right adjacent chroma sampling positions, the position L2″ corresponding to the left sample corresponds to the position L1″ corresponding to the right sample, and the position L5″ corresponding to the left sample corresponds to the position L4″ corresponding to the right sample.

It can be learned that, according to the prediction method provided in embodiments of this application, the luma reconstructed value is filtered, so that the first chroma predicted value may be corrected, thereby further reducing the prediction residual. This scheme proposes a method for screening luma samples participating in model parameter calculation and application. When calculating the model parameter, it is determined whether the luma sample residual at L0 is 0. If the luma sample residual is 0, the chroma prediction sample at the corresponding position and the luma prediction sample closest to the chroma prediction sample do not participate in the model parameter calculation. When the model is applied, it is determined whether the luma sample residual at L0″ is 0. If the luma sample residual is 0, the chroma prediction sample at the corresponding position is not corrected. To some extent, prediction accuracy is improved, and encoding complexity is ensured.

That is, the prediction method provided in embodiments of this application provides a method for screening a luma sample that participates in model parameter calculation and application. The chroma prediction sample corresponding to the luma sample residual 0 at L0″ is not corrected, thereby ensuring algorithm effectiveness while considering complexity, and effectively improving the encoding efficiency.

It should be noted that in embodiments of this application, a luma sample and a chroma sample whose residual is 0 at a corresponding position are not used in only a process of calculating the model parameter. In an application process, all samples in the chroma prediction block are corrected.

It should be noted that, in embodiments of this application, if no luma sample participates in model parameter calculation or application, the prediction method provided in embodiments of this application may not be applied.

An embodiment of this application provides a prediction method. A prediction reference block of the current block is determined according to a prediction parameter of the current block, where the prediction reference block includes a luma prediction reference block and a chroma prediction reference block, a size of the luma prediction reference block is the same as a size of the luma block of the current block, and a size of the chroma prediction reference block is the same as a size of the chroma block of the current block. A reconstructed value of the luma component of the current block is determined according to the residual value of the luma component of the current block and the luma prediction reference block. According to the chroma sample in the chroma prediction reference block, a model reference luma sample set corresponding to the chroma sample is determined. Model parameters of the cross-component prediction model are determined according to the model reference luma sample set, the residual value of the luma component of the current block, and the prediction reference block of the current block. According to the chroma sample in the chroma prediction reference block, a prediction reference luma sample set corresponding to the chroma sample is determined. A predicted value of a chroma component of the current block is determined according to the model parameter of the cross-component prediction model, the prediction reference luma sample set, the residual value of the luma component of the current block, and the reconstructed value of the luma component of the current block. That is, in embodiments of this application, in a process of determining the model parameter of the cross-component prediction model, the luma sample that participates in model parameter derivation can be screened according to the residual value of the luma component of the current block. In addition, in a process of applying the cross-component prediction model, the luma sample can also be screened according to the residual value of the luma component of the current block. Therefore, in a process of model derivation and application, whether to use the luma prediction sample can be determined according to prediction accuracy of the luma prediction sample, so that a model parameter that can more accurately reflect a relationship between the luma prediction sample and the chroma prediction sample can be obtained. At the same time, a better correction effect can be obtained, thereby improving accuracy of the chroma prediction, and further improving the coding performance.

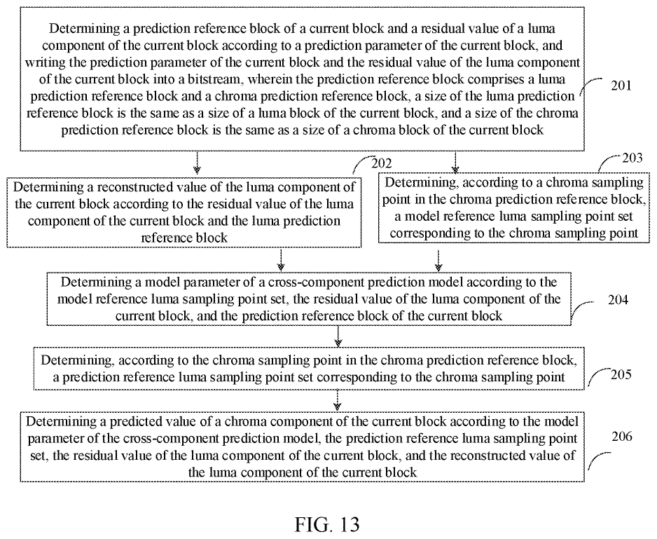

Another embodiment of this application provides an encoding method. The encoding method is applied to an encoder. FIG. 13 is a schematic flowchart of an encoding method according to an embodiment of this application. As shown in FIG. 13, the encoding method performed by the encoder may perform the following steps 201 to 206.

In step 201, a prediction reference block of the current block and a residual value of a luma component of the current block are determined according to a prediction parameter of the current block, and the prediction parameter of the current block and the residual value of the luma component of the current block are written into a bitstream. The prediction reference block includes a luma prediction reference block and a chroma prediction reference block. A size of the luma prediction reference block is the same as a size of the luma block of the current block, and a size of the chroma prediction reference block is the same as a size of the chroma block of the current block.

In embodiments of this application, the prediction reference block of the current block and the residual value of the luma component of the current block may be determined according to the prediction parameter of the current block, and the prediction parameter of the current block and the residual value of the luma component of the current block may be written into the bitstream and transmitted to the decoding side.

It should be noted that the encoding method in embodiments of this application is applied to an encoder. In addition, the encoding method may include a prediction method, and more specifically, a picture component prediction method. A video picture may be divided into multiple coding blocks, and each coding block may include a first color component, a second color component, and a third color component. In embodiments of this application, the current block refers to a currently to-be-predicted coding block in the video picture.

Herein, when the first color component needs to be predicted, the to-be-predicted component is the first color component; when the second color component needs to be predicted, the to-be-predicted component is the second color component; and when the third color component needs to be predicted, the to-be-predicted component is the third color component. In addition, assuming that a first color component of the current block is to be predicted, and the first color component is a luma component, that is, the to-be-predicted component is the luma component, the current block may also be referred to as a luma block. Alternatively, assuming that a second color component of the current block is to be predicted, and the second color component is a chroma component, that is, the to-be-predicted component is the chroma component, the current block may also be referred to as a chroma block.

It should be noted that, in embodiments of this application, the prediction parameter corresponding to the current block may be used to determine a prediction block of the luma component and a prediction block of the chroma component corresponding to the current block.

It may be understood that, in embodiments of this application, the prediction parameter of the current block may be used to determine a parameter of a prediction manner used when the current block is predicted.

For example, in some embodiments, the prediction parameter of the current block may include at least one of the following parameters: an inter prediction parameter, an intra block copy (IBC) parameter, an inter template matching parameter, or an intra template matching parameter.

It should be noted that in embodiments of this application, the prediction parameter of the current block may further include other parameters and information of any type, and the prediction parameter of the current block is not specifically limited in this application.

In embodiments of this application, the prediction reference block of the current block may be determined according to the prediction parameter of the current block.

It should be noted that in embodiments of this application, the prediction reference block of the current block may include a luma prediction reference block corresponding to the luma component and a chroma prediction reference block corresponding to the chroma component.

That is, in embodiments of this application, the luma component and the chroma component of the current block may be separately predicted based on the prediction parameter, so that the corresponding luma prediction reference block and chroma prediction reference block may be determined, that is, the prediction reference block of the current block is determined.

It should be noted that in embodiments of this application, when determining the prediction reference block of the current block according to the prediction parameter of the current block, the prediction reference block of the current block may be determined based on the inter prediction parameter by using the inter prediction. That is, inter prediction may be separately performed on the luma component and the chroma component of the current block based on the inter prediction parameter, so that the corresponding luma prediction reference block and chroma prediction reference block may be determined.

It should be noted that in embodiments of this application, when the prediction reference block of the current block is determined according to the prediction parameter of the current block, the prediction reference block of the current block may be determined based on an IBC parameter by using the IBC. That is, the IBC prediction may be separately performed on the luma component and the chroma component of the current block based on the IBC parameter, so that the corresponding luma prediction reference block and chroma prediction reference block may be determined.

It should be noted that, in embodiments of this application, when the prediction reference block of the current block is determined according to the prediction parameter of the current block, the prediction reference block of the current block may be determined based on an inter template matching parameter by using the inter template matching. That is, the inter template matching prediction may be separately performed on the luma component and the chroma component of the current block based on the inter template matching parameter, so that the corresponding luma prediction reference block and chroma prediction reference block may be determined.

It should be noted that in embodiments of this application, when determining the prediction reference block of the current block according to the prediction parameter of the current block, the prediction reference block of the current block is determined based on an intra template matching parameter by using the intra template matching. That is, the intra template matching prediction may be separately performed on the luma component and the chroma component of the current block based on the intra template matching parameter, so that the corresponding luma prediction reference block and chroma prediction reference block may be determined.

For example, in some embodiments, based on the prediction parameters of the current block, the prediction reference block may also be obtained using any of the following methods: the inter/BV-based prediction in GPM, the inter/BV-based prediction block in CIIP, etc.

Further, in embodiments of this application, a size of the luma prediction reference block is the same as a size of the luma block of the current block, and a size of the chroma prediction reference block is the same as a size of the chroma block of the current block.

That is, in embodiments of this application, the prediction reference block determined by using the prediction parameter is equal to the current block in size.

Step 202: Determine a reconstructed value of the luma component of the current block according to the residual value of the luma component of the current block and the predicted reference block of the luma.

In this embodiment of this application, after the residual value of the luma component of the current block and the luma predicted reference block of the current block are determined, the reconstruction value of the luma component of the current block may be further determined according to the residual value of the luma component of the current block and the luma predicted reference block.

It should be noted that in this embodiment of this application, when determining the reconstruction value of the luma component of the current block according to the residual value of the luma component of the current block and the luma prediction reference block, a sum value between the residual value of the luma component of the current block and the prediction value corresponding to the luma prediction reference block may be determined as the reconstruction value of the luma component of the current block.

In step 203, according to the chroma sample in the chroma prediction reference block, a model reference luma sample set corresponding to the chroma sample is determined.

In embodiments of this application, after the prediction reference block including the luma prediction reference block and the chroma prediction reference block of the current block is determined based on the prediction parameter, the model reference luma sample set corresponding to the chroma sample may be further determined according to the chroma sample in the chroma prediction reference block.

It should be noted that in this embodiment of this application, when the chroma sample is selected from the chroma prediction reference block, all samples in the chroma prediction reference block may be selected as the chroma sample, or some of the samples in the chroma prediction reference block may be selected by using a downsampling manner as the chroma sample.

It may be understood that in embodiments of this application, to reduce a quantity of luma and chroma prediction samples (that is, a quantity of chroma samples and a quantity of luma samples) that participate in model parameter calculation, downsampling may be first performed on the chroma prediction block, so that the chroma sample is determined from the chroma prediction block.

Further, in embodiments of this application, a downsampling step may be first determined according to a size parameter of the chroma prediction reference block. Then, the chroma prediction reference block is downsampled according to the downsampling step to determine the chroma sample.

It should be noted that in embodiments of this application, a downsampling step dsX and a downsampling step dsY in the x direction and the y direction are first determined according to the chroma prediction reference block width and height, so that downsampling may be performed on the chroma prediction reference block by using the downsampling step, and finally a downsampled chroma prediction value, that is, a chroma sample, is obtained.

It may be understood that in embodiments of this application, the model reference luma sample set determined based on the chroma sample may include the luma sample used for model parameter derivation.

It should be noted that in embodiments of this application, the chroma sample may be some or all samples in the chroma prediction reference block. Correspondingly, the luma sample may also be some or all samples in the luma prediction reference block that correspond to the chroma sample. The correspondence between the chroma sample and the luma sample may be determined based on a chroma format parameter of the current block.

That is, in embodiments of this application, the chroma sample that is used to determine the model parameter of the cross-component prediction model may be all samples in the chroma prediction reference block, or may be some samples in the chroma prediction reference block, which is not specifically limited in this application.

Further, in embodiments of this application, when determining, according to the chroma sample in the chroma prediction reference block, the model reference luma sample set corresponding to the chroma sample, the chroma format parameter may be first determined. Then, the luma sample corresponding to the chroma sample may be determined in the luma prediction reference block according to the chroma format parameter and the chroma sample in the chroma prediction reference block. Finally, the model reference luma sample set may be determined according to the luma sample.

It should be noted that, in embodiments of this application, the chroma format of the current block may be determined according to the chroma format parameter, and the chroma format parameter is written into a bitstream.

It may be understood that, in embodiments of this application, the chroma format parameter may be used to indicate a chroma format corresponding to the current block. The chroma format may be a picture color format, and may include 4:4:4, 4:2:2, and 4:2:0.

Exemplarily, in some embodiments, the chroma format parameter may be represented by using sps_chroma_format_idc. When a value of the chroma format parameter is a first value, it is determined that the current block is of the first chroma format; when the value of the chroma format parameter is a second value, it is determined that the current block is of the second chroma format; or when the value of the chroma format parameter is a third value, it is determined that the current block is of the third chroma format.

It should be noted that in in embodiments of this application, the first value, the second value, and the third value are different, and the first value, the second value, and the third value may be in a parameter form, or may be in a digital form. Specifically, the chroma format parameter may be a parameter written in the parameter set, or may be a value of a flag (flag), which is not specifically limited herein.

In addition, for the first value, the second value, and the third value, the first value may be set to 0, the second value may be set to 1, and the third value may be set to 2. Alternatively, the first value may be set to 2, the second value may be set to 1, and the third value may be set to 0. In embodiments of this application, the first value is set to 0, the second value is set to 1, and the third value is set to 2, which is not specifically limited.

It should be noted that in embodiments of this application, the first chroma format may be 4:4:4, the second chroma format may be 4:2:2, and the third chroma format may be 4:2:0.

Further, in embodiments of this application, when the luma sample corresponding to the chroma sample is determined in the luma block of the current block according to the chroma format parameter and the chroma sample in the chroma block of the current block, related luma coordinates may be first determined in the luma prediction reference block according to the chroma format parameter and chroma sample coordinates in the chroma prediction reference block. Then, the sample corresponding to the related luma coordinates may be determined as the luma sample corresponding to the chroma sample.

It may be understood that, in embodiments of this application, the related luma coordinates may be coordinates that are in the luma prediction reference block and that correspond to coordinates of the chroma sample. The correspondence between the coordinates may be determined by using the chroma format parameter. Based on different chroma format parameters, the finally determined related luma coordinates are different.

For example, in some embodiments, chroma sample coordinates of the chroma sample may be (xC, yC).

Correspondingly, in embodiments of this application, when the related luma coordinates are determined in the luma prediction reference block according to the chroma format parameter and the chroma sample coordinates of the chroma sample in the chroma prediction reference block, the related luma coordinates (xY, yY) determined in the luma prediction reference block according to the chroma sample coordinates (xC, yC) may include first coordinates L0 (xC, yC), if the current block is of the first chroma format.

It may be understood that, in embodiments of this application, for the first chroma format 4:4:4, each Y component corresponds to a group of Cb and Cr components. In this case, the first coordinates L0 (xC, yC) corresponding to the same position as the coordinates of the chroma sample may be obtained in the luma prediction reference block as the related luma coordinates, that is, the sample of the first coordinates L0 (xC, yC) in the luma prediction reference block is the corresponding luma sample.

That is, in embodiments of this application, in a case in which the current block is of the first chroma format, the determined model reference luma sample set includes a luma sample of first coordinates L0 (xC, yC) corresponding to the chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, and when the current block is of the second chroma format, the related luma coordinates (xY, yY) determined in the luma prediction reference block according to the chroma sample coordinates (xC, yC) includes second coordinates L1 (xC<<1, yC), third coordinates L2 (xC<<1−1, yC), and fourth coordinates L3 (xC<<1+1, yC).

It may be understood that, in embodiments of this application, for the second chroma format 4:2:2, every two Y components share one group of Cb and Cr components. If the coordinates of the chroma sample are (xC, yC), the related luma coordinates corresponding to the coordinates of the chroma sample in the luma prediction reference block are the second coordinates L1 (xC<<1, yC), the third coordinates L2 (xC<<1−1, yC), and the fourth coordinates L3 (xC<<1+1, yC), that is, the samples having the second coordinates L1 (xC<<1, yC), the third coordinates L2 (xC<<1−1, yC), and the fourth coordinates L3 (xC<<1+1, yC) in the luma prediction reference block are corresponding luma samples.

That is, in embodiments of this application, in a case in which the current block is of a second chroma format, the determined model reference luma sample set includes luma samples having second coordinates L1 (xC<<1, yC), third coordinates L2 (xC<<1−1, yC), and fourth coordinates L3 (xC<<1+1, yC) that correspond to the chroma sample coordinates (xC, yC).

Correspondingly, in embodiments of this application, when the related luma coordinates are determined in the luma prediction reference block according to the chroma format parameter and the coordinates of the chroma sample in the chroma prediction reference block, and when the current block is of a third chroma format, the related luma coordinates (xY, yY) determined in the luma prediction reference block according to the chroma sample coordinates (xC, yC) includes: fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1).

It may be understood that, in embodiments of this application, for the third chroma format 4:2:0, every four Y components share one group of Cb and Cr components. If the coordinates of the chroma sample are (xC, yC), the related luma coordinates corresponding to the coordinates of the chroma sample in the luma prediction reference block are the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), the tenth coordinates L9 (xC<<1+1, yC<<1+1), that is, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) in the luma prediction reference block are corresponding luma samples.

That is, in embodiments of this application, in a case in which the current block is of a third chroma format, the determined model reference luma sample set includes luma samples having fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1) that correspond to chroma sample coordinates (xC, yC).

It should be noted that, in embodiments of this application, << is a left shift operator, where m<<n indicates that an operation of a left shift by n bits is performed on a binary number of m, a result of m<<n is m×2ⁿ, and m and n are integers greater than 0.

That is, in embodiments of this application, the luma sample includes a co-located sample of the chroma sample in the luma prediction reference block, and/or a sample adjacent to the co-located sample.

For example, in some embodiments, the luma sample may include a co-located sample of the chroma sample in the luma prediction reference block, such as a sample having coordinates (xY, yY), and/or a sample that is adjacent to the co-located sample, such as samples having coordinates (xY−1, yY), (xY+1, yY), (xY, yY+1), (xY−1, yY+1), and (xY+1, yY+1).

In step 204, a model parameter of a cross-component prediction model is determined according to the model reference luma sample set, a residual value of the luma component of the current block, and a prediction reference block of the current block.

In embodiments of this application, after determining the model reference luma sample set corresponding to the chroma samples based on the chroma samples in the chroma prediction reference block, the model parameters of the cross-component prediction model may be further determined based on the model reference luma sample set, the residual value of the luma component of the current block, and the prediction reference block of the current block.

It should be noted that in embodiments of this application, after determining the chroma sample that is used to derive the model parameter of the cross-component prediction model and the corresponding model reference luma sample set, the luma sample and the chroma sample may be further screened with reference to the residual value of the luma component of the current block, and the model parameter of the cross-component prediction model is further determined by using the screened sample whose residual value meets a requirement.

Further, in embodiments of this application, when the model parameter of the cross-component prediction model is determined according to the model reference luma sample set, the residual value of the luma component of the current block, and the prediction reference block of the current block, a first availability parameter of the luma sample in the model reference luma sample set may be first determined according to the residual value of the luma component of the current block. Then, the model parameter of the cross-component prediction model may be determined according to the first availability parameter and the prediction reference block of the current block.

It should be noted that, in embodiments of this application, the first availability parameter may be used to indicate whether to use the luma sampling value of the luma sample. For a luma sample, if a corresponding first availability parameter indicates “available”, it may be understood that a luma sampling value of the luma sample is used. If the corresponding first availability parameter indicates “unavailable”, it may be understood that the luma sampling value of the luma sample is not used.

Further, in embodiments of this application, when the first availability parameter of the luma sample in the model reference luma sample set is determined according to the residual value of the luma component of the current block, in a case in which the residual value of the luma component of the current block corresponding to the luma sample meets the first condition, the first availability parameter of the luma sample indicates that the luma sampling value of the luma sample is not used. In a case in which the residual value of the luma component of the current block corresponding to the luma sample does not meet the first condition, the first availability parameter of the luma sample indicates that the luma sampling value of the luma sample is used.

It should be noted that, in embodiments of this application, for a luma sample, a residual value of the luma component of the current block at the luma sampling coordinates of the luma sample, i.e., a value corresponding to the luma sample, may be determined first, and then it is determined whether the residual value at the luma sampling coordinates meets a first condition. If the residual value meets the first condition, the first availability parameter of the luma sample is determined as “unavailable”, that is, it indicates that the luma sampling value of the luma sample is not used. Otherwise, the first availability parameter of the luma sample is determined as “available”, that is, it indicates that the luma sampling value of the luma sample is used.

It may be understood that, in embodiments of this application, the first condition may be used to distinguish and screen the residual value with reference to a preset first residual threshold. The first condition may include: a residual value of the luma component of the current block corresponding to a luma sample is less than or equal to the first residual threshold.

It should be noted that in embodiments of this application, a value of the first residual threshold may be any preset value. For example, the first residual threshold may be 0, or may be 4.

That is, in embodiments of this application, when the first availability parameter is determined for the luma reference point, the residual value of the luma component corresponding to the luma sample may be compared with the first residual threshold. If a comparison result is that the residual value of the luma component corresponding to the luma sample is less than or equal to the first residual threshold, it may be determined that the luma prediction accuracy of the luma sample is relatively high. It may be considered that the model parameter obtained by deriving by using the luma sampling value of the luma sample is not applicable to the sample with low prediction accuracy. Therefore, the luma sampling value of the luma sample may be not selected, that is, the first availability parameter of the luma sample indicates that the luma sampling value of the luma sample is not used.

Correspondingly, in embodiments of this application, if the comparison result is that the residual value of the luma component corresponding to the luma sample is greater than the first residual threshold, it may be determined that the luma prediction accuracy of the luma sample is relatively low. It may be considered that the model parameter obtained by deriving by using the luma sampling value of the luma sample may be applicable to a sample with low prediction accuracy. Therefore, the luma sampling value of the luma sample may be used, that is, it may be determined that the first availability parameter of the luma sample indicates that the luma sampling value of the luma sample is used.

It should be noted that, in embodiments of this application, the first availability parameter may be determined by comparing the residual value of the luma component corresponding to the luma sample with the first residual threshold, or the first availability parameter may be determined in any other manner. For example, the residual value of the luma component corresponding to the luma sample is shifted right by 2 bits, and then compared with the first residual threshold.

Exemplarily, in some embodiments, assuming that the first residual threshold is 0. The luma sample is screened according to the residual value of the luma component of the current block. If the residual value of the luma component of the current block corresponding to the luma sample is 0, that is, is less than or equal to the first residual threshold, the model parameter is not derived by using the luma sampling value of the luma sample. If the residual value of the luma component of the current block corresponding to the luma sample is not 0, that is, is greater than the first residual threshold, the model parameter is derived by using the luma sampling value of the luma sample.

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value, the chroma sampling value, a nonlinear term, and/or an offset term.

It should be noted that, in embodiments of this application, the cross-component prediction model may include InterCCCM. The cross-component prediction model may be an 8-tap filter including six spatial luma samples, the non-linear term, and the offset term, such as the foregoing formula (3).

Exemplarily, in some embodiments, for a chroma sample, if a residual value of a luma sample corresponding to the chroma sample (that is, a luma residual of the luma component of the current block corresponding to the luma sample) is greater than a first residual threshold, that is, a first availability parameter corresponding to the luma sample indicates that a model parameter may be derived by using the luma sampling value of the luma sample, a luma sampling value corresponding to the luma sample may be determined according to the luma prediction reference block, and a chroma sampling value corresponding to the chroma sample may be determined according to the chroma prediction reference block. Then, based on the foregoing formulas (4) and (5), a model parameter c₀~c₇ is determined with reference to the nonlinear term and/or the offset term. In which, the model parameter c₀~c₇ may be obtained by solving the equation, for example, using a division-free Gaussian elimination method.

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample is determined according to the luma prediction reference block, and the chroma sampling value corresponding to the chroma sample is determined according to the chroma prediction reference block. Then, the model parameter of the cross-component prediction model is determined according to the luma sampling value, the chroma sampling value, and the offset term. That is, in a process of determining the model parameter, the non-linear term may not be used.

It should be noted that in embodiments of this application, the cross-component prediction model may include InterCCCM. The cross-component prediction model may be an 8-tap filter including six spatial luma samples and an offset term, as shown in formula (8).

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value, the chroma sampling value, and the non-linear term. That is, in a process of determining the model parameter, the offset term may not be used.

It should be noted that in embodiments of this application, the cross-component prediction model may include InterCCCM, and the cross-component prediction model may be an 8-tap filter including six spatial luma samples and an offset term, as shown in formula (9).

Further, in embodiments of this application, when the model parameter of the cross-component prediction model is determined according to the first availability parameter and the prediction reference block of the current block, in a case in which the first availability parameter indicates that the luma sampling value of the luma sample is used, the luma sampling value corresponding to the luma sample may be determined according to the luma prediction reference block, and the chroma sampling value corresponding to the chroma sample may be determined according to the chroma prediction reference block. Then, the model parameter of the cross-component prediction model is determined according to the luma sampling value and the chroma sampling value. That is, in a process of determining the model parameter, the offset term and the non-linear term may not be used.

That is, in embodiments of this application, the model parameter of the cross-component prediction model may be determined without using the offset term and the non-linear term.

It should be noted that, in embodiments of this application, the cross-component prediction model may include InterCCCM. The cross-component prediction model may be an 8-tap filter including six spatial luma samples and an offset term, as shown in formula (10).

Further, in embodiments of this application, when determining, according to the luma prediction reference block, the luma sampling value corresponding to the luma sample, a luma predicted value of the luma prediction reference block corresponding to the luma sample may be determined as the luma sampling value. Alternatively, in a case in which the luma predicted value of the luma prediction reference block corresponding to the luma sample is not 0, the luma sampling value may be determined according to the luma offset value and the luma predicted value.

Further, in embodiments of this application, when the chroma sampling value corresponding to the chroma sample is determined according to the chroma prediction reference block, the chroma predicted value of the chroma sample corresponding to the chroma prediction reference block may be determined as the chroma sampling value. Alternatively, the chroma sampling value may be determined according to the chroma offset value and the chroma predicted value of the chroma sample corresponding to the chroma prediction reference block.

It may be understood that in embodiments of this application, in a process of calculating a model parameter, to reduce a dynamic range of data and bit depth required by the derivation, a luma offset value and a chroma offset value may be introduced.

For example, in some embodiments, the luma offset value may be subtracted from the luma predicted value participating in the model parameter calculation, so as to obtain a corresponding luma sampling value, and then the model parameter is calculated by using the luma sampling value.

For example, in some embodiments, the chroma offset value may be subtracted from the chroma prediction value obtained by participating in the model parameter calculation, so as to obtain a corresponding chroma sampling value, and then the model parameter is calculated by using the chroma sampling value.

It should be noted that in embodiments of this application, the luma offset value (offsetY) and the chroma offset value (offsetCb for the Cb component and offsetCr for the Cr component) may be simply represented by an average value of the four vertex pixel values of the luma prediction block and the chroma prediction block.

It may be understood that, in embodiments of this application, the offset value may not be applied to a calculation process of the model parameter, that is, the luma offset value (offsetY) and the chroma offset value (offsetCb for the Cb component and offsetCr for the Cr component) may not be introduced.

That is, in embodiments of this application, in a process of calculating the model parameter, the finally used luma sampling value L0′~L5′ is a difference between the luma predicted value L0~L5 (the value is not 0) corresponding to the luma sample and the luma offset value offsetY, and finally, an equation between the chroma sampling value predChromaVal and L0′~L5′, the nonlinear term as well as the offset term is established, and the model parameter c₀~c₇ may be obtained by using, for example, a division-free Gaussian elimination method in ECM10.0.

It should be noted that, in embodiments of this application, for different chroma formats indicated by different chroma format parameters, the chroma sample may correspond to different quantities of luma samples. For example, for the first chroma format 4:4:4, one chroma sample corresponds to one luma sample. For the second chroma format 4:2:2, one chroma sample corresponds to three luma samples. For the third chroma format 4:2:0, one chroma sample corresponds to six luma samples. That is, the chroma sample corresponds to at least one luma sample. In a process of determining the first availability parameter of the luma sample, the first availability parameter may be determined based on some or all of the at least one luma sample. This is not specifically limited in this application.

That is, in embodiments of this application, for the at least one luma sample, in a case in which a residual value corresponding to any one of the luma samples is less than or equal to a first residual threshold, it is determined that the first availability parameter corresponding to all the luma samples indicates “unavailable”.

Correspondingly, in embodiments of this application, for the at least one luma sample, in a case in which residual values corresponding to all the luma samples are less than or equal to the first residual threshold, it is determined that the first availability parameters corresponding to all the luma samples indicate “unavailable”.

Exemplarily, in some embodiments, assuming that the first residual threshold is 0. For the first chroma format 4:4:4, each Y component corresponds to a group of Cb and Cr components. In this case, a sample having the first coordinates L0 (xC, yC) co-located with the chroma sample coordinates in the luma prediction reference block may be determined as the corresponding luma sample. If the residual value of the luma component of the current block corresponding to the luma sample L0 (xC, yC) is 0, it may be considered that the first availability parameter corresponding to the luma sample represents “unavailable”. Therefore, neither the chroma sampling value of the (xC, yC) position nor the luma sampling value of the corresponding first coordinates L0 (xC, yC) position participates in the model parameter calculation.

Exemplarily, in some embodiments, assuming that the first residual threshold is 0. For the second chroma format 4:2:2, every two Y components share a group of Cb and Cr components. In this case, samples having the second coordinates L1 (xC<<1, yC), the third coordinates L2 (xC<<1−1, yC), and the fourth coordinates L3 (xC<<1+1, yC) that are co-located with the chroma sample coordinates in the luma prediction reference block may be determined as the corresponding luma sample. If the residual value of the luma component of the current block corresponding to the luma sample L1 (xC<<1, yC) is 0, it may be considered that the first availability parameter corresponding to all the luma samples indicates “unavailable”. Therefore, neither the chroma sampling value of the (xC, yC) position nor the luma sampling value of the corresponding second coordinates L1 (xC<<1, yC), third coordinates L2 (xC<<1−1, yC), and fourth coordinates L3 (xC<<1+1, yC) position participate in the model parameter calculation.

Exemplarily, in some embodiments, assuming that the first residual threshold is 0. For the third chroma format 4:2:0, every four Y components share a group of Cb and Cr components. In this case, luma samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) that are co-located with the chroma sample coordinates in the luma prediction reference block may be determined as the corresponding luma samples. If the residual value of the luma component of the current block corresponding to the luma sample L4 (xC<<1, yC<<1) is 0, it may be considered that the first availability parameter corresponding to all luma samples represents “unavailable”. Therefore, the chroma sampling value at the (xC, yC) position and the luma sampling value at the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) do not participate in the model parameter calculation.

It may be understood that, in embodiments of this application, when determining samples not participating in the model parameter calculation and/or the model application, the samples may be determined not only according to the luma residual value corresponding to the L0 location, but also according to multiple residual values in the L0~L5. For example, the samples may be determined according to L0 and L1, L0 and L3, or L0~L2. Alternatively, the samples may be determined according to the chroma residual value of the position corresponding to the chroma sample being 0.

It should be noted that, in embodiments of this application, if the first availability parameters corresponding to all the luma samples in the model reference luma sample set indicate “unavailable”, the luma sample and the chroma sample are no longer screened and distinguished, but the model parameter is derived by using the chroma sampling value of the chroma sample and the luma sampling value of the luma sample.

In step 205, according to the chroma sample in the chroma prediction reference block, a prediction reference luma sample set corresponding to the chroma sample is determined.

In embodiments of this application, after the prediction reference block of the current block that includes the luma prediction reference block and the chroma prediction reference block is determined based on the prediction parameter, the prediction reference luma sample set corresponding to the chroma sample may be further determined according to the chroma sample in the chroma prediction reference block.

It should be noted that in embodiments of this application, in an application process of the cross-component prediction model, when the chroma sample is selected from the chroma prediction reference block, all samples in the chroma prediction reference block may be selected as the chroma sample.

That is, in the embodiments of this application, when the model parameter of the cross-component prediction model is determined, downsampling processing may be performed on the chroma prediction reference block. When the cross-component prediction model is applied, all samples in the chroma prediction reference block need to be used as chroma samples.

Further, in embodiments of this application, when determining, according to the chroma sample in the chroma prediction reference block, a prediction reference luma sample set corresponding to the chroma sample, the chroma format parameter may be first determined. Then, the luma sample corresponding to the chroma sample may be determined in the luma prediction reference block according to the chroma format parameter and the chroma sample in the chroma prediction reference block. Finally, the prediction reference luma sample set may be determined according to the luma sample.

It should be noted that, in embodiments of this application, the chroma format of the current block may be determined according to the chroma format parameter.

It may be understood that, in embodiments of this application, the chroma format parameter may be used to indicate a chroma format corresponding to the current block. The chroma format may be a picture color format, and may include 4:4:4, 4:2:2, and 4:2:0.

Further, in embodiments of this application, when the luma sample corresponding to the chroma sample is determined in the luma block of the current block according to the chroma format parameter and the chroma sample in the chroma block of the current block, the related luma coordinates may be first determined in the luma prediction reference block according to the chroma format parameter and the chroma sample coordinates in the chroma prediction reference block. Then, the sample corresponding to the related luma coordinates may be determined as the luma sample corresponding to the chroma sample.

It may be understood that, in embodiments of this application, the related luma coordinates may be coordinates that are in the luma prediction reference block and that correspond to coordinates of the chroma sample. The correspondence between the coordinates may be determined by using the chroma format parameter. Based on different chroma format parameters, the finally determined related luma coordinates are different.

For example, in some embodiments, chroma sample coordinates of the chroma sample may be (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of a first chroma format, the related luma coordinates (xY, yY) determined in the luma prediction reference block according to the chroma sample coordinates (xC, yC) may include the first coordinates L0 (xC, yC).

It may be understood that, in embodiments of this application, for the first chroma format 4:4:4, each Y component corresponds to a group of Cb and Cr components. In this case, the first coordinates L0 (xC, yC) corresponding to the same position as the coordinates of the chroma sample may be obtained in the luma prediction reference block as the related luma coordinates, that is, the sample having the first coordinates L0 (xC, yC) in the luma prediction reference block is the corresponding luma sample.

That is, in embodiments of this application, in a case in which the current block is of a first chroma format, the determined prediction reference luma sample set includes a luma sample having first coordinates L0 (xC, yC) corresponding to chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of the second chroma format, the related luma coordinates (xY, yY) determined in the luma prediction reference block according to the chroma sample coordinates (xC, yC) includes the second coordinates L1 (xC<<1, yC), the third coordinates L2 (xC<<1−1, yC), and the fourth coordinates L3 (xC<<1+1, yC).

It may be understood that, in embodiments of this application, for the second chroma format 4:2:2, every two Y components share one group of Cb and Cr components. If the coordinates of the chroma sample are (xC, yC), the related luma coordinates corresponding to the coordinates of the chroma sample in the luma prediction reference block are the second coordinates L1 (xC<<1, yC), the third coordinates L2 (xC<<1−1, yC), and the fourth coordinates L3 (xC<<1+1, yC). That is, the samples having the second coordinates L1 (xC<<1, yC), the third coordinates L2 (xC<<1−1, yC), and the fourth coordinates L3 (xC<<1+1, yC) in the luma prediction reference block are corresponding luma samples.

That is, in embodiments of this application, in a case in which the current block is of a second chroma format, the determined prediction reference luma sample set includes luma samples having second coordinates L1 (xC<<1, yC), third coordinates L2 (xC<<1−1, yC), and fourth coordinates L3 (xC<<1+1, yC) that correspond to the chroma sample coordinates (xC, yC).

Correspondingly, in embodiments of this application, when the related luma coordinates are determined in the luma prediction reference block according to the chroma format parameter and the chroma sample coordinates of the chroma sample in the chroma prediction reference block, in a case in which the current block is of a third chroma format, the related luma coordinates (xY, yY) determined in the luma prediction reference block according to the chroma sample coordinates (xC, yC) includes: fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1).

It may be understood that, in embodiments of this application, for the third chroma format 4:2:0, every four Y components share one group of Cb and Cr components. If the coordinates of the chroma sample are (xC, yC), the related luma coordinates corresponding to the coordinates of the chroma sample in the luma prediction reference block are the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), the tenth coordinates L9 (xC<<1+1, yC<<1+1). That is, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) in the luma prediction reference block are corresponding luma samples.

That is, in embodiments of this application, in a case in which the current block is of a third chroma format, the determined prediction reference luma sample set includes luma samples having fifth coordinates L4 (xC<<1, yC<<1), sixth coordinates L5 (xC<<1−1, yC<<1), seventh coordinates L6 (xC<<1+1, yC<<1), eighth coordinates L7 (xC<<1, yC<<1+1), ninth coordinates L8 (xC<<1−1, yC<<1+1), and tenth coordinates L9 (xC<<1+1, yC<<1+1) that correspond to chroma sample coordinates (xC, yC).

It should be noted that, in embodiments of this application, <<is a left shift operator, where m<<n indicates that an operation of a left shift by n bits is performed on a binary number of m, a result of m<<n is m×2ⁿ, and m and n are integers greater than 0.

That is, in embodiments of this application, the luma sample includes a co-located sample of the chroma sample in the luma prediction reference block, for example a sample having the first coordinates L0 (xC, yC), and/or a sample adjacent to the co-located sample.

For example, in some embodiments, the luma sample may include a co-located sample of the chroma sample in the luma prediction reference block, such as a sample of coordinates (xY, yY), and/or a sample that is adjacent to the co-located sample, such as samples having coordinates (xY−1, yY), (xY+1, yY), (xY, yY+1), (xY−1, yY+1), and (xY+1, yY+1).

In step 206, a predicted value of the chroma component of the current block is determined according to the model parameter of the cross-component prediction model, the prediction reference luma sample set, the residual value of the luma component of the current block, and the reconstructed value of the luma component of the current block.

In this embodiment of this application, after the prediction reference luma sample set corresponding to the chroma sample is determined according to the chroma sample in the chroma prediction reference block, and the model parameter of the cross-component prediction model is determined according to the model reference luma sample set, the residual value of the luma component of the current block, and the prediction reference block of the current block, the predicted value of the chroma component of the current block may be further determined according to the model parameter of the cross-component prediction model, the prediction reference luma sample set, the residual value of the luma component of the current block, and the reconstructed value of the luma component of the current block.

It should be noted that in this embodiment of this application, after determining the prediction reference luma sample set that uses the cross-component prediction model, the luma sample and the chroma sample may be further screened with reference to the residual value of the luma component of the current block, and the corrected chroma predicted value of the cross-component prediction model is used for the screened sample whose residual value meets a requirement.

Further, in embodiments of this application, when determining the predicted value of the chroma component of the current block according to the model parameter of the cross-component prediction model, the prediction reference luma sample set, the residual value of the luma component of the current block, and the reconstructed value of the luma component of the current block, the second availability parameter of the luma sample in the prediction reference luma sample set may be first determined according to the residual value of the luma component of the current block. Then, the predicted value of the chroma component of the current block may be determined according to the second availability parameter, the model parameter of the cross-component prediction model, and the reconstructed value of the luma component of the current block.

It should be noted that, in embodiments of this application, the second availability parameter may be used to indicate whether to use the luma reconstructed value of the luma sample. For a luma sample, if a corresponding second availability parameter indicates “available”, it may be understood that the luma reconstructed value of the luma sample is used. If the corresponding second availability parameter indicates “unavailable”, it may be understood that the luma reconstructed value of the luma sample is not used.

Further, in embodiments of this application, when the second availability parameter of the luma sample in the prediction reference luma sample set is determined according to the residual value of the luma component of the current block, in a case in which the residual value of the luma component of the current block corresponding to the luma sample meets the second condition, it may be determined that the second availability parameter of the luma sample indicates that the luma reconstructed value of the luma sample is not used. In a case in which the residual value of the luma component of the current block corresponding to the luma sample does not meet the second condition, it may be determined that the second availability parameter of the luma sample indicates that the luma reconstructed value of the luma sample is used.

It should be noted that, in embodiments of this application, for a luma sample, the residual value of the luma component of the current block at luma sampling coordinates of the luma sample is determined first, that is, a value corresponding to the luma sample. Then, it is determined whether the residual value of the luma sampling coordinate meets a second condition. If the residual value meets the second condition, it is determined that the second availability parameter of the luma sample is “unavailable”, that is, it indicates that the luma reconstructed value of the luma sample is not used. Otherwise, it is determined that the second availability parameter of the luma sample is “available”, that is, it indicates that the luma reconstructed value of the luma sample is used.

It may be understood that, in embodiments of this application, the second condition may be used to distinguish and screen the residual value with reference to a preset second residual threshold. The second condition may include: a residual value of the luma component of the current block corresponding to a luma sample is less than or equal to a second residual threshold.

It should be noted that, in embodiments of this application, the first residual threshold may be the same as or different from the second residual threshold, and this application sets no specific limitation thereto. The value of the second residual threshold may be any preset value. For example, the second residual threshold may be 0, or may be 4.

That is, in embodiments of this application, when the second availability parameter is determined for the luma reference point, the residual value of the luma component corresponding to the luma sample may be compared with the second residual threshold. If a comparison result is that the residual value of the luma component corresponding to the luma sample is less than or equal to the second residual threshold, it may be determined that the luma prediction accuracy of the luma sample is relatively high. It may be considered that the luma reconstructed value of the luma sample is not applicable to correction of the chroma predicted value of the sample with low prediction accuracy. Therefore, the luma reconstructed value of the luma sample may be not used, that is, it may be determined that the second availability parameter of the luma sample indicates that the luma reconstructed value of the luma sample is not used.

Correspondingly, in embodiments of this application, if the comparison result is that the residual value of the luma component corresponding to the luma sample is greater than the second residual threshold, it may be determined that the luma prediction accuracy of the luma sample is relatively low. It may be considered that the luma reconstructed value of the luma sample is applicable to correction of the chroma predicted value of a sample with low prediction accuracy. Therefore, the luma reconstructed value of the luma sample may be used, that is, it may be determined that the second availability parameter of the luma sample indicates that the luma reconstructed value of the luma sample is used.

It should be noted that, in embodiments of this application, the second availability parameter may be determined by comparing the residual value of the luma component corresponding to the luma sample with the second residual threshold, or the second availability parameter may be determined in any other manner. For example, the residual value of the luma component corresponding to the luma sample is shifted right by 2 bits, and then compared with the second residual threshold.

For example, in some embodiments, assuming that the second residual threshold is 0. The luma sample is screened according to the residual value of the luma component of the current block. If the residual value of the luma component of the current block corresponding to the luma sample is 0, that is, is less than or equal to the second residual threshold, the luma reconstructed value of the luma sample is not used. If the residual value of the luma component of the current block corresponding to the luma sample is not 0, that is, is greater than the second residual threshold, the luma reconstructed value of the luma sample is used.

Further, in embodiments of this application, when the predicted value of the chroma component of the current block is determined according to the second availability parameter, the model parameter of the cross-component prediction model, and the reconstructed value of the luma component of the current block, in a case in which the second availability parameter indicates that the luma reconstructed value of the luma sample is used, it is determined that the reconstructed value of the luma component of the current block corresponds to the luma reconstructed value of the luma sample. Then, the predicted value of the chroma component of the current block may be determined according to the luma reconstructed value, the model parameter, the nonlinear term, and/or the offset term.

It should be noted that, in embodiments of this application, the cross-component prediction model may include InterCCCM. The cross-component prediction model may be an 8-tap filter including six spatial luma samples, a non-linear term, and an offset term, such as the foregoing formula (3).

Exemplarily, in some embodiments, for a chroma sample, if a residual value of a luma sample corresponding to the chroma sample (that is, a luma residual of a luma component of a current block corresponding to the luma sample) is greater than a second residual threshold, that is, a second availability parameter corresponding to the luma sample indicates that a luma reconstructed value of the luma sample may be used, a luma reconstructed value of the luma sample may be determined according to the reconstructed value of the luma component of the current block. Then, a chroma predicted value is corrected based on the foregoing formula (4) and (5), a nonlinear term and/or an offset term, and a model parameter c₀~c₇ obtained by derivation, and the corrected chroma predicted value of a corresponding chroma sample is determined, thereby determining a predicted value of the chroma component of the current block.

Further, in embodiments of this application, when the predicted value of the chroma component of the current block is determined according to the second availability parameter, the model parameter of the cross-component prediction model, and the reconstructed value of the luma component of the current block, in a case in which the second availability parameter indicates that the luma reconstructed value of the luma sample is used, it is determined that the reconstructed value of the luma component of the current block corresponds to the luma reconstructed value of the luma sample. Then, the predicted value of chroma component of the current block may be determined according to the luma reconstructed value, the model parameter, and the offset term. That is, in a model application process, a non-linear term may not be used.

It should be noted that in embodiments of this application, the cross-component prediction model may include InterCCCM. The cross-component prediction model may be an 8-tap filter including six spatial luma samples and an offset term, as shown in formula (8).

Further, in embodiments of this application, when the predicted value of the chroma component of the current block is determined according to the second availability parameter, the model parameter of the cross-component prediction model, and the reconstructed value of the luma component of the current block, in a case in which the second availability parameter indicates that the luma reconstructed value of the luma sample is used, it is determined that the reconstructed value of the luma component of the current block corresponds to the luma reconstructed value of the luma sample. Then, the predicted value of the chroma component of the current block may be determined according to the luma reconstructed value, the model parameter, and the nonlinear term. That is, in a model application process, an offset term may not be used.

It should be noted that in embodiments of this application, the cross-component prediction model may include InterCCCM, and the cross-component prediction model may be an 8-tap filter including six spatial luma samples and an offset term, as shown in formula (9).

Further, in embodiments of this application, when the predicted value of the chroma component of the current block is determined according to the second availability parameter, the model parameter of the cross-component prediction model, and the reconstructed value of the luma component of the current block, in a case in which the second availability parameter indicates that the luma reconstructed value of the luma sample is used, it is determined that the reconstructed value of the luma component of the current block corresponds to the luma reconstructed value of the luma sample. Then, the predicted value of the chroma component of the current block may be determined according to the luma reconstructed value and the model parameter. That is, in a model application process, an offset term and a non-linear term may not be used.

That is, in embodiments of this application, an offset term and a non-linear term may be not used when the model is applied.

It should be noted that, in embodiments of this application, the cross-component prediction model may include InterCCCM. The cross-component prediction model may be an 8-tap filter including six spatial luma samples and an offset term, as shown in formula (10).

Further, in embodiments of this application, when determining, according to the luma prediction reference block, the luma sampling value corresponding to the luma sample, a value of the luma prediction reference block corresponding to the luma sample may be selected as the luma reconstructed value. Alternatively, if the value of the luma prediction reference block corresponding to the luma sample is not 0, the luma reconstructed value may be determined based on the luma offset value and the value corresponding to the luma sample.

It may be understood that, in embodiments of this application, in a process of using a model parameter, to reduce a dynamic range of data and to bit depth required by the derivation, a luma offset value may be introduced.

For example, in some embodiments, the luma offset value may be subtracted from the luma reconstructed value participating in model application, so as to obtain a corresponding luma reconstructed value, and further, the luma reconstructed value is used to correct the chroma predicted value.

It should be noted that in embodiments of this application, the luma offset value (offsetY) may be simply represented by using an average value of four vertex pixel values of the luma prediction block.

That is, in embodiments of this application, in a model application process, a finally used luma reconstructed value L0′~L5′ is a difference between a reconstructed value L0″~L5″ (the value is not 0) corresponding to the luma sample and a luma offset value offsetY.

It should be noted that, in embodiments of this application, for different chroma formats indicated by different chroma format parameters, the chroma sample may correspond to different quantities of luma samples. For example, for the first chroma format 4:4:4, one chroma sample corresponds to one luma sample. For the second chroma format 4:2:2, one chroma sample corresponds to three luma samples. For the second chroma format 4:2:0, one chroma sample corresponds to six luma samples. That is, the chroma sample corresponds to at least one luma sample. In a process of determining the first availability parameter of the luma sample, a corresponding first availability parameter may be determined based on some or all of the at least one luma sample. This is not specifically limited in this application.

That is, in embodiments of this application, for the at least one luma sample, in a case in which a residual value corresponding to any one of the luma samples is less than or equal to a second residual threshold, it is determined that the second availability parameters corresponding to all the luma samples each indicate “unavailable”.

Correspondingly, in embodiments of this application, for at least one luma sample, in a case in which residual values corresponding to all luma samples each are less than or equal to the second residual threshold, it is determined that the second availability parameters corresponding to all luma samples each indicate “unavailable”.

Exemplarily, in some embodiments, assuming that the second residual threshold is 0. For the first chroma format 4:4:4, each Y component corresponds to a group of Cb and Cr components. In this case, a sample having the first coordinates L0 (xC, yC) co-located with the chroma sample coordinates in the luma prediction reference block may be determined as the corresponding luma sample. If the residual value of the luma component of the current block corresponding to the luma sample L0 (xC, yC) is 0, it may be considered that the second availability parameter corresponding to the luma sample represents “unavailable”. Therefore, none of the luma reconstructed values corresponding to the first coordinate L0 (xC, yC) participates in the model application.

Exemplarily, in some embodiments, assuming that the second residual threshold is 0. For the second chroma format 4:2:2, every two Y components share a group of Cb and Cr components. In this case, samples having the second coordinates L1 (xC<<1, yC), the third coordinates L2 (xC<<1−1, yC), and the fourth coordinates L3 (xC<<1+1, yC) that are in the luma prediction reference block and are co-located with the chroma sample coordinates may be determined as the corresponding luma samples. If the residual value of the luma component of the current block corresponding to the luma sample L1 (xC<<1, yC) is 0, it may be considered that the second availability parameter corresponding to all the luma samples indicates “unavailable”. Therefore, the corresponding luma reconstructed values at the second coordinates L1 (xC<<1, yC), the third coordinates L2 (xC<<1−1, yC), and the fourth coordinates L3 (xC<<1+1, yC) do not participate in the model application.

Exemplarily, in some embodiments, assuming that the second residual threshold is 0. For the third chroma format 4:2:0, every four Y components share a group of Cb and Cr components. In this case, samples having the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) that are in the luma prediction reference block and are co-located with the chroma sample coordinates are determined as the corresponding luma samples. If the residual value of the luma component of the current block corresponding to the luma sample L4 (xC<<1, yC<<1) is 0, it may be considered that the second availability parameter corresponding to all the luma samples represents “unavailable”. Therefore, none of the corresponding luma reconstructed values at the fifth coordinates L4 (xC<<1, yC<<1), the sixth coordinates L5 (xC<<1−1, yC<<1), the seventh coordinates L6 (xC<<1+1, yC<<1), the eighth coordinates L7 (xC<<1, yC<<1+1), the ninth coordinates L8 (xC<<1−1, yC<<1+1), and the tenth coordinates L9 (xC<<1+1, yC<<1+1) participates in the model application.

It should be noted that, in embodiments of this application, if the second availability parameters corresponding to all luma samples in the prediction reference luma sample set each represent “unavailable”, the luma sample and the chroma sample are no longer screened and distinguished, but the model application continues to be performed by using the luma reconstructed value of the luma sample.

Further, in embodiments of this application, when determining the predicted value of the chroma component of the current block according to the luma reconstructed value, the model parameter, the non-linear term, and/or the offset term, a chroma prediction correction block of the current block may be first determined according to the luma reconstructed value, the model parameter, the non-linear term, and/or the offset term. Then, the predicted value of the chroma component of the current block may be determined according to a preset weight, the chroma prediction reference block, and the chroma prediction correction block.

It should be noted that, in embodiments of this application, after the correction to the chroma component of the current block is completed by using the cross-component prediction model, the chroma prediction correction block of the current block corresponding to the chroma prediction reference block of the current block may be determined, and then the chroma prediction reference block and the chroma prediction correction block may be weighted by using a preset weight to obtain a predicted value of the chroma component of the current block. That is, the predicted value of the chroma component of the current block may be obtained by performing a weighted operation on an initial predicted value (chroma prediction reference block) of the chroma component of the current block and the corrected predicted value (chroma prediction correction block) of the chroma component of the current block.

For example, in some embodiments, based on the foregoing formula (3), the chroma prediction correction block of the current block is determined according to the luma reconstructed value, the model parameter, the nonlinear term, and/or the offset term. That is, after the corrected predicted value of the chroma component of the current block (predCbVal for the Cb component, predCrVal for the Cr component) is obtained, a weighting operation may be further performed on the corrected predicted value of the chroma component and the chroma prediction reference block, that is, the initial prediction value of the chroma component of the current block (predSamplesCb for the Cb component, predSamplesCr for the Cr component). For example, the foregoing formula (6) and (7) are used to perform a weighting operation, so that a final predicted value of the chroma component (predSamplesCb′ for the Cb component, predsamplescr′ for the Cr Component) may be obtained.

It should be noted that in embodiments of this application, the preset weight may be a preset value, and the preset weight may be greater than or equal to 0 and less than or equal to 1. For example, the preset weight w is 0.75.

Further, in embodiments of this application, when the predicted value of the chroma component of the current block is determined according to the luma reconstruction value, the model parameter, the nonlinear term, and/or the offset term, the chroma prediction correction block of the current block may be first determined according to the luma reconstructed value, the model parameter, the nonlinear term, and/or the offset term. In addition, a first weight may be determined according to the residual value of the luma component of the current block. Then, the predicted value of the chroma component of the current block may be determined according to the first weight, the chroma prediction reference block, and the chroma prediction correction block.

It should be noted that, in embodiments of this application, the weight used to perform the weighting operation on the initial prediction value (chroma prediction reference block) of the chroma component of the current block and the corrected prediction value (chroma prediction correction block) of the chroma component of the current block may be the first weight. The first weight may be determined by using the residual value of the luma component of the current block.

It may be understood that, in embodiments of this application, when the first weight is determined according to the residual value of the luma component of the current block, for the luma sample, a smaller residual value corresponding to the luma sample may indicate a more accurate predicted position corresponding to the luma sample. In this case, for the determined first weight, a larger weight value may be assigned to an initial predicted value of the corresponding chroma sample.

That is, in embodiments of this application, when the weighting operation is performed on the chroma prediction reference block and the chroma prediction correction block, the weight may be determined by using the residual value of the luma sample corresponding to the chroma sample. That is, the first weight is determined according to the residual value of the luma component of the current block. If the residual value of the corresponding luma sample is smaller, it may be considered that the prediction value of the chroma sample at the corresponding position is more accurate, and therefore, the weight of the corresponding chroma prediction reference block is larger.

For example, in some embodiments, it is assumed that an absolute value of a prediction residual of a luma sample at L0″ is AbsResLuma. In this case, if AbsResLuma<5, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.75:0.25, so that a final predicted value of the chroma component (predSamplesCb′ for a Cb component, predSamplesCr′ for a Cr component) may be obtained, as shown by the following formulas (11) and (12).

For example, it is assumed that an absolute value of a prediction residual of a luma sample at L0″ is AbsResLuma. In this case, if 5≤AbsResLuma<20, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.5:0.5, so that a final predicted value of the chroma component (predSamplesCb′ for a Cb component, predSamplesCr′ for a Cr component) may be obtained, as shown by the following formulas (13) and (14).

For example, in some embodiments, it is assumed that an absolute value of a prediction residual of a luma sample at L0″ is AbsResLuma. In this case, if 20≤AbsResLuma, a weighting operation is performed on a predicted value of a chroma sample in the chroma prediction reference block (predSamplesCb for a Cb component, predSamplesCr for a Cr component) and a predicted value of a corresponding position in a chroma prediction correction block (predCbVal for a Cb component, predCrVal for a Cr component) according to 0.25:0.75, so that a final predicted value of the chroma component (predSamplesCb′ for a Cb component, predSamplesCr′ for a Cr component) may be obtained, as shown by the following formulas (15) and (16).

Further, in this embodiment of this application, when the predicted value of the chroma component of the current block is determined according to the luma reconstructed value, the model parameter, the nonlinear term, and/or the offset term, the chroma prediction correction block of the current block may be first determined according to the luma reconstructed value, the model parameter, the nonlinear term, and/or the offset term. In addition, a nonlinear weighting coefficient may be determined. Then, the predicted value of the chroma component of the current block may be determined according to the first weight, the chroma prediction reference block, and the chroma prediction correction block.

It should be noted that in this embodiment of this application, the initial predicted value (chroma prediction reference block) of the chroma component of the current block and the corrected predicted value (chroma prediction correction block) of the chroma component of the current block may be weighted in a non-linear weighting manner. That is, when the weighting operation is performed on the chroma prediction reference block and the chroma prediction correction block, the determined nonlinear weighting coefficient may be used to perform nonlinear weighting on the chroma prediction reference block and the chroma prediction correction block.

For example, in some embodiments, when determining a final predicted value of the chroma component (predSamplesCb′ for a Cb component, predSamplesCr′ for a Cr component), nonlinear weighting is performed on a predicted value of a chroma sample in the chroma prediction reference block (predSamplesCb for a Cb component, predSamplesCr for a Cr component) and a predicted value of a corresponding position in the chroma prediction correction block (predCbVal for a Cb component, predCrVal for a Cr component) according to the foregoing formulas (17) and (18).

In which, the nonlinear term nonlinear and the offset term B are determined by using the foregoing formula (4) and formula (5). a₀~a₇ represents a nonlinear weighting coefficient, and may be derived from the reference template of the current chroma prediction block (an upper row and a left column of the current chroma prediction block).

For example, in some embodiments, it is assumed that the first chroma predicted value (predRefCb for the Cb component, predRefCr for the Cr component), the second chroma predicted value (predRefCbVal for the Cb component, predRefCrVal for the Cr component), and the chroma reconstructed value (recRefCb for the Cb component, recRefCr for the Cr component) of the reference template. The equation may be established according to the following formulas (19) and (20), and the model coefficient a₀~a₇ may be solved by using, for example, a division-free Gaussian elimination method in ECM-10.0:

In which, the nonlinear term nonlinear and the offset term B are determined by using the foregoing formula (4) and formula (5).

It should be noted that in embodiments of this application, for luma samples for which the second availability parameters each indicate “unavailable”, the luma samples and the chroma samples may no longer be screened and distinguished.

In conclusion, the encoding method proposed in step 201 to step 206 mainly includes a method for screening a luma sample (a luma sample) that participates in model parameter calculation and application. The luma reconstructed value may be filtered, so that the chroma predicted value may be corrected, and the prediction residual is further reduced. In one aspect, when calculating the model parameter, it may be determined whether the luma sample residual of the luma sample is less than or equal to the first residual threshold. If the luma sample residual of the luma sample is less than or equal to the first residual threshold, the chroma prediction sample at the corresponding position and the luma prediction sample closest to the chroma prediction sample do not participate in calculation of the model parameter. In another aspect, when the model is applied, it may be determined whether the luma sample residual of the luma sample is less than or equal to the second residual threshold. If the luma sample residual of the luma sample is less than or equal to the second residual threshold, the chroma prediction sample at the corresponding position is not corrected.

It can be learned that according to the decoding method provided in embodiments of this application, in a process of calculating and applying the model parameters, chroma predicted values corresponding to luma samples with relatively high prediction accuracy are not corrected, for example, chroma prediction samples corresponding to luma samples residual 0 at L0″ are not corrected, so that prediction accuracy is improved to some extent, and encoding complexity is ensured.

An embodiment of this application provides an encoding method. A prediction reference block of a current block is determined according to a prediction parameter of the current block. The prediction reference block includes a luma prediction reference block and a chroma prediction reference block, a size of the luma prediction reference block is the same as a size of a luma block of the current block, and a size of the chroma prediction reference block is the same as a size of a chroma block of the current block. A reconstructed value of the luma component of the current block is determined according to the residual value of the luma component of the current block and the luma prediction reference block. According to the chroma sample in the chroma prediction reference block, a model reference luma sample set corresponding to the chroma sample is determined. Model parameters of the cross-component prediction model are determined according to the model reference luma sample set, the residual value of the luma component of the current block, and the prediction reference block of the current block. According to the chroma sample in the chroma prediction reference block, a prediction reference luma sample set corresponding to the chroma sample is determined. The predicted value of the chroma component of the current block is determined according to the model parameter of the cross-component prediction model, the prediction reference luma sample set, the residual value of the luma component of the current block, and the reconstructed value of the luma component of the current block. That is, in embodiments of this application, in a process of determining the model parameter of the cross-component prediction model, the luma sample that participates in model parameter derivation may be screened according to the residual value of the luma component of the current block. In addition, in a process of applying the cross-component prediction model, the luma sample may also be screened according to the residual value of the luma component of the current block. Therefore, in a process of model derivation and application, whether to use the luma prediction sample may be determined according to prediction accuracy of the luma prediction sample, so that a model parameter that can more accurately reflect a relationship between the luma prediction sample and the chroma prediction sample may be obtained. At the same time, a better correction effect may be obtained, thereby improving accuracy of the chroma prediction, and further improving the coding performance.

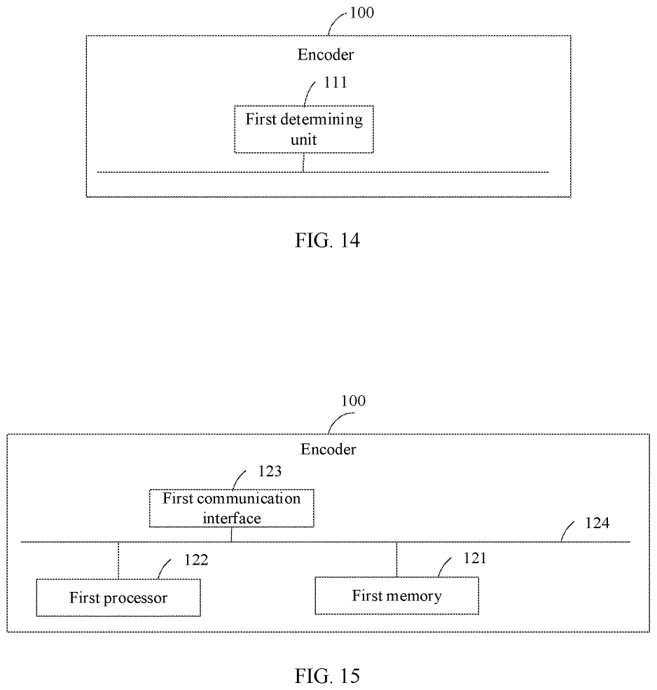

In still another embodiment of this application, based on a same invention concept of the foregoing embodiment, FIG. 14 is a schematic structural diagram 1 of an encoder according to an embodiment of this application. As shown in FIG. 14, the encoder 100 may include a first determining unit 111.

Based on the foregoing composition of the encoder 100 and a computer readable storage medium, FIG. 15 is a schematic structural diagram 2 of an encoder according to an embodiment of this application. As shown in FIG. 15, the encoder 100 may include a first memory 121, a first processor 122, a first communications interface 123, and a first bus system 124. The first memory 121, the first processor 122, and the first communications interface 123 are coupled together by using the first bus system 124. It may be understood that the first bus system 124 is configured to implement connection and communication between these components. In addition to a data bus, the first bus system 124 further includes a power bus, a control bus, and a status signal bus. However, for clear description, various buses are marked as the first bus system 124 in the figure.

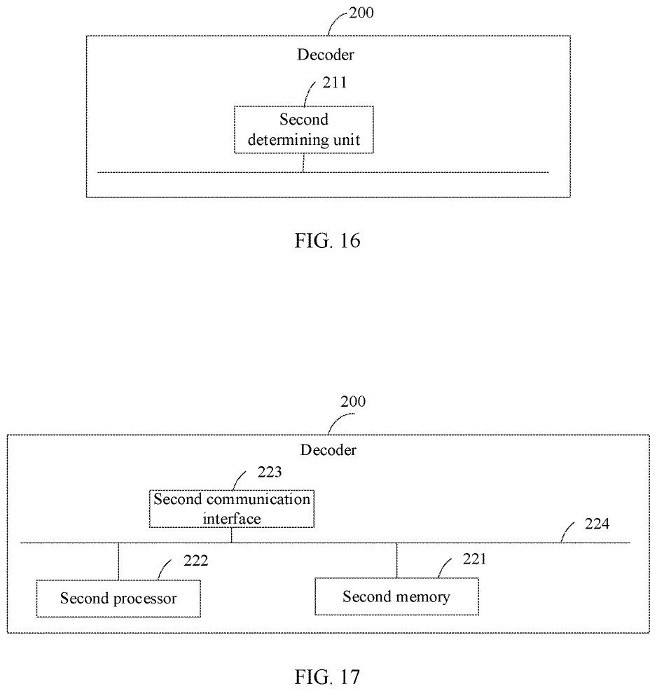

In still another embodiment of this application, based on a same invention concept of the foregoing embodiment, FIG. 16 is a schematic structural diagram 1 of composition of a decoder according to an embodiment of this application. As shown in FIG. 16, the decoder 200 may include a second determining unit 211.

The second determining unit 211 is configured to: decode a bitstream to determine a prediction parameter of a current block and a residual value of a luma component of the current block; determine a prediction reference block of the current block according to the prediction parameter of the current block, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block; determine a reconstructed value of the luma component of the current block according to the residual value of the luma component of the current block and the luma prediction reference block; determine, according to a chroma sample in the chroma prediction reference block, a model reference luma sample set corresponding to the chroma sample; determine a model parameter of a cross-component prediction model according to the model reference luma sample set, the residual value of the luma component of the current block, and the prediction reference block of the current block; determine, according to the chroma sample in the chroma prediction reference block, a prediction reference luma sample set corresponding to the chroma sample; and determine a predicted value of a chroma component of the current block according to the model parameter of the cross-component prediction model, the prediction reference luma sample set, the residual value of the luma component of the current block, and the reconstructed value of the luma component of the current block.

Based on the foregoing composition of the decoder 200 and a computer readable storage medium, FIG. 17 is a schematic structural diagram 2 of a decoder according to an embodiment of this application. As shown in FIG. 17, the decoder 200 may include a second memory 221, a second processor 222, a second communications interface 223, and a second bus system 224. The second memory 221 and the second processor 222 are coupled together by using the second bus system 224. It may be understood that the second bus system 224 is configured to implement connection and communication between these components. In addition to a data bus, the second bus system 224 further includes a power bus, a control bus, and a status signal bus. However, for clarity of description, various buses are marked as the second bus system 224 in the figure.

The second communications interface 223 is configured to receive and transmit a signal in a process of transmitting and receiving information between the second communications interface 223 and another external network element.

The second memory 221 is configured to store a computer program that can run on the second processor.

The second processor 222 is configured to: when running the computer program, decode a bitstream to determine a prediction parameter of a current block and a residual value of a luma component of the current block; determine a prediction reference block of the current block according to the prediction parameter of the current block, where the prediction reference block includes a luma prediction reference block and a chroma prediction reference block, a size of the luma prediction reference block is the same as a size of a luma block of the current block, and a size of the chroma prediction reference block is the same as a size of a chroma block of the current block; determine a reconstructed value of the luma component of the current block according to the residual value of the luma component of the current block and the luma prediction reference block; determine, according to a chroma sample in the chroma prediction reference block, a model reference luma sample set corresponding to the chroma sample; determine a model parameter of a cross-component prediction model according to the model reference luma sample set, the residual value of the luma component of the current block, and the prediction reference block of the current block; determine, according to the chroma sample in the chroma prediction reference block, a prediction reference luma sample set corresponding to the chroma sample; and determine a predicted value of a chroma component of the current block according to the model parameter of the cross-component prediction model, the prediction reference luma sample set, the residual value of the luma component of the current block, and the reconstructed value of the luma component of the current block.

What is claimed is:

1. A decoding method, applied to a decoder, wherein the method comprises:
decoding a bitstream to determine a prediction parameter of a current block and a residual value of a luma component of the current block;
determining a prediction reference block of the current block according to the prediction parameter of the current block, wherein the prediction reference block comprises a luma prediction reference block and a chroma prediction reference block, a size of the luma prediction reference block is the same as a size of a luma block of the current block, and a size of the chroma prediction reference block is the same as a size of a chroma block of the current block;
determining a reconstructed value of the luma component of the current block according to the residual value of the luma component of the current block and the luma prediction reference block;
determining, according to a chroma sample in the chroma prediction reference block, a model reference luma sample set corresponding to the chroma sample;
determining a model parameter of a cross-component prediction model according to the model reference luma sample set, the residual value of the luma component of the current block, and the prediction reference block of the current block;
determining, according to the chroma sample in the chroma prediction reference block, a prediction reference luma sample set corresponding to the chroma sample; and
determining a predicted value of a chroma component of the current block according to the model parameter of the cross-component prediction model, the prediction reference luma sample set, the residual value of the luma component of the current block, and the reconstructed value of the luma component of the current block.

2. The method according to claim 1, wherein the prediction parameter comprises at least one of the following parameters: an inter prediction parameter, an intra block copy IBC parameter, an inter template matching parameter, or an intra template matching parameter.

3. The method according to claim 2, wherein the determining a prediction reference block of the current block according to the prediction parameter of the current block comprises:
determining a prediction reference block of the current block based on the inter prediction parameter by using inter prediction; and/or
determining a prediction reference block of the current block based on the IBC parameter by using IBC; and/or
determining a prediction reference block of the current block based on the inter template matching parameter by using inter template matching; and/or
determining a prediction reference block of the current block based on the intra template matching parameter by using intra template matching.

4. The method according to claim 1, wherein the determining, according to the chroma sample in the chroma prediction reference block, a model reference luma sample set corresponding to the chroma sample comprises:
determining a chroma format parameter;
determining, according to the chroma format parameter and the chroma sample in the chroma prediction reference block, a luma sample corresponding to the chroma sample in the luma prediction reference block; and
determining a model reference luma sample set according to the luma sample.

5. The method according to claim 4, wherein the determining a chroma format parameter comprises:
decoding the bitstream to determine the chroma format parameter;
and/or wherein
when a value of the chroma format parameter is a first value, determining that the current block is of a first chroma format;
when a value of the chroma format parameter is a second value, determining that the current block is of a second chroma format; or
when a value of the chroma format parameter is a third value, determining that the current block is of a third chroma format.

6. The method according to claim 5, wherein the determining, according to the chroma format parameter and the chroma sample in the chroma block of the current block, a luma sample corresponding to the chroma sample in the luma block of the current block comprises:
determining related luma coordinates in the luma prediction reference block according to the chroma format parameter and chroma sample coordinates of the chroma sample in the chroma prediction reference block; and
determining a sample corresponding to the related luma coordinates as the luma sample corresponding to the chroma sample.

7. The method according to claim 6, wherein coordinates of the chroma sample are (xC, yC);
and/or wherein the determining related luma coordinates in the luma prediction reference block according to the chroma format parameter and chroma sample coordinates of the chroma sample in the chroma prediction reference block comprises:
in a case in which the current block is of the first chroma format, the related luma coordinates (xY, yY) determined in the luma prediction reference block according to the chroma sample coordinates (xC, yC) comprise first coordinates L0 (xC, yC).

8. The method according to claim 7, wherein the determining related luma coordinates in the luma prediction reference block according to the chroma format parameter and chroma sample coordinates of the chroma sample in the chroma prediction reference block comprises:
in a case in which current block is of the second chroma format, the related luma coordinates (xY, yY) determined in the luma prediction reference block according to the chroma sample coordinates (xC, yC) comprise second coordinates L0 (xC<<1, yC), third coordinates L1 (xC<<1−1, yC), and fourth coordinates L2 (xC<<1+1, yC).

9. The method according to claim 7, wherein the determining related luma coordinates in the luma prediction reference block according to the chroma format parameter and chroma sample coordinates of the chroma sample in the chroma prediction reference block comprises:
in a case in which the current block is of the third chroma format, the related luma coordinates (xY, yY) determined in the luma prediction reference block according to the chroma sample coordinates (xC, yC) comprise: fifth coordinates L0 (xC<<1, yC<<1), sixth coordinates L1 (xC<<1−1, yC<<1), seventh coordinates L2 (xC<<1+1, yC<<1), eighth coordinates L3 (xC<<1, yC<<1+1), ninth coordinates L4 (xC<<1−1, yC<<1+1), and tenth coordinates L5 (xC<<1+1, yC<<1+1).

10. The method according to claim 8, wherein
<<is a left shift operator, where m<<n indicates that an operation of a left shift by n bits is performed on a binary number of m, a result of m<<n is m×2ⁿ, and m and n are integers greater than 0.

11. The method according to claim 7, wherein
the luma sample comprises a co-located sample of the chroma sample in the luma prediction reference block, and/or a sample adjacent to the co-located sample.

12. The method according to claim 4, further comprising:
determining a down-sampling step according to a size parameter of the chroma prediction reference block; and
performing down-sampling on the chroma prediction reference block according to the down-sampling step to determine the chroma sample.

13. The method according to claim 4, further comprising:
determining all samples in the chroma prediction reference block as the chroma samples.

14. The method according to claim 1, wherein the determining a model parameter of a cross-component prediction model according to the model reference luma sample set, a residual value of a luma component of the current block, and a prediction reference block of the current block comprises:
determining a first availability parameter of a luma sample in the model reference luma sample set according to the residual value of the luma component of the current block, wherein the first availability parameter is used to indicate whether to use a luma sampling value of the luma sample; and
determining a model parameter of the cross-component prediction model according to the first availability parameter and the prediction reference block of the current block.

15. The method according to claim 14, wherein the determining a first availability parameter of a luma sample in the model reference luma sample set according to the residual value of the luma component of the current block comprises:
when the residual value of the luma component of the current block corresponding to the luma sample meets a first condition, determining that a first availability parameter of the luma sample indicates that the luma sampling value of the luma sample is not used; and
when the residual value of the luma component of the current block corresponding to the luma sample does not meet the first condition, determining that the first availability parameter of the luma sample indicates that the luma sampling value of the luma sample is used.

16. The method according to claim 15, wherein
the first condition comprises: a residual value of the luma component of the current block corresponding to the luma sample is less than or equal to a first residual threshold.

17. The method according to claim 14, wherein the determining a model parameter of the cross-component prediction model according to the first availability parameter and a prediction reference block of the current block comprises:
when the first availability parameter indicates that the luma sampling value of the luma sample is used, determining, according to the luma prediction reference block, the luma sampling value corresponding to the luma sample, and determining, according to the chroma prediction reference block, a chroma sampling value corresponding to the chroma sample; and
determining a model parameter of the cross-component prediction model according to the luma sampling value, the chroma sampling value, a nonlinear term, and/or an offset term.

18. An encoding method, applied to an encoder, wherein the method comprises:
determining a prediction reference block of a current block and a residual value of a luma component of the current block according to a prediction parameter of the current block, and writing the prediction parameter of the current block and the residual value of the luma component of the current block into a bitstream, wherein the prediction reference block comprises a luma prediction reference block and a chroma prediction reference block, a size of the luma prediction reference block is the same as a size of a luma block of the current block, and a size of the chroma prediction reference block is the same as a size of a chroma block of the current block;
determining a reconstructed value of the luma component of the current block according to the residual value of the luma component of the current block and the luma prediction reference block;
determining, according to a chroma sample in the chroma prediction reference block, a model reference luma sample set corresponding to the chroma sample;
determining a model parameter of a cross-component prediction model according to the model reference luma sample set, the residual value of the luma component of the current block, and the prediction reference block of the current block;
determining, according to the chroma sample in the chroma prediction reference block, a prediction reference luma sample set corresponding to the chroma sample; and
determining a predicted value of a chroma component of the current block according to the model parameter of the cross-component prediction model, the prediction reference luma sample set, the residual value of the luma component of the current block, and the reconstructed value of the luma component of the current block.

19. A decoder, comprising a processor, wherein
the processor is configured to decode a bitstream to determine a prediction parameter of a current block and a residual value of a luma component of the current block; determine a prediction reference block of the current block according to the prediction parameter of the current block, wherein the prediction reference block comprises a luma prediction reference block and a chroma prediction reference block, a size of the luma prediction reference block is the same as a size of a luma block of the current block, and a size of the chroma prediction reference block is the same as a size of a chroma block of the current block; determining a reconstructed value of the luma component of the current block according to the residual value of the luma component of the current block and the luma prediction reference block; determine, according to a chroma sample in the chroma prediction reference block, a model reference luma sample set corresponding to the chroma sample; determine a model parameter of a cross-component prediction model according to the model reference luma sample set, the residual value of the luma component of the current block, and the prediction reference block of the current block; determine, according to the chroma sample in the chroma prediction reference block, a prediction reference luma sample set corresponding to the chroma sample; and
determine a predicted value of a chroma component of the current block according to the model parameter of the cross-component prediction model, the prediction reference luma sample set, the residual value of the luma component of the current block, and the reconstructed value of the luma component of the current block.

20. A computer readable storage medium storing a computer program/instruction and a bitstream wherein the computer program/instruction is executed by a processor to implement the method according to claim 18 to generate the bitstream.
